(19) United States
(12) Patent Application Publication
(10) Pub. No.: US 2019/0018211 A1
(43) Pub. Date: Jan. 17, 2019

(54) SEALING INTERFACE FOR AN ENCLOSURE

(71) Applicant: COMMSCOPE CONNECTIVITY BELGIUM BVBA, Diestsesteenweg 692 (BE)

(72) Inventors: Maarten AERTS, Deinze (BE); Eric SCHURMANS, Geetbets (BE); David Jan Irma VAN BAELEN, Winksele (BE); Valja EVERAERT, Wetteren (BE); Stephane COLLART, Turnhout (BE)

(21) Appl. No.: 16/070,234

(22) PCT Filed: Jan. 13, 2017
(86) PCT No.: PCT/EP2017/050644

§ 371 Date: Jul. 13, 2018

Related U.S. Application Data
(60) Provisional application No. 62/278,878, filed on Jan. 14, 2016.
(60) Provisional application No. 62/356,922, filed on Jun. 30, 2016.

(51) Int. Cl. G02B 6/44; H02G 15/013; H02G 15/113; H02G 3/08

(52) U.S. Cl. CPC G02B 6/4446; H02G 3/088; H02G 15/113; H02G 15/013

(57) ABSTRACT

Aspects and techniques of the present disclosure relate to an IP 55 rated enclosure that does not use a rubber O-ring or comparable elastomeric sealing member disposed between pieces of the enclosure to provide sealing. Another aspect of the present disclosure relates to an IP 55 compliant sealing interface that includes mating sealing profiles made of the identical materials. A further aspect of the present disclosure relates to an enclosure having jet stream redirecting structures that prevent spray from a water jet from being sprayed directly into an ingress path defined by a sealing interface. A further aspect of the present disclosure relates to a sealing interface provided by an interference-fit between two plastic profiles which create pressure on the interface keeping it closed while concurrently including angled surfaces so that greater tolerances are allowed.

### CROSS-REFERENCE TO RELATED APPLICATIONS

This application claims the benefit of U.S. Patent Application Ser. No. 62/278,878, filed on Jan. 14, 2016, and claims the benefit of U.S. Patent Application Ser. No. 62/356,922, filed on Jun. 30, 2016, the disclosures of which are incorporated herein by reference in their entireties.

### TECHNICAL FIELD

The present disclosure relates to sealed enclosures for use in telecommunications and/or electrical applications.

### BACKGROUND

Enclosures (e.g., telecommunications and electrical enclosures) are typically sealed to inhibit the intrusion of foreign materials such as dust and moisture. By inhibiting the intrusion of foreign materials, internal components housed within the enclosures can be protected from damage. Standards have been established for defining the levels of sealing effectiveness for enclosures. For example, International Standard EN 60529 published by the International Electrotechnical Commission (IEC) sets forth ingress protection ratings used to define levels of sealing effectiveness for enclosures. The IP code (e.g., International Protection rating or Ingress Protection rating) set forth by International Standard EN 60529 consists of the letters IP followed by two numerical digits. The numbers that follow the IP have a defined meaning. The first digit indicates the level of ingress protection provided relating to solids such as dust. The second digit indicates the level of ingress protection provided relating to liquids such as water. By way of example, an enclosure rated for ingress protection level IP 55 provides protection from limited dust ingress and also provides protection from low pressure water jets.

### SUMMARY

One aspect of the present disclosure relates to an IP 55 rated enclosure that does not use a rubber O-ring or comparable elastomeric sealing member disposed between pieces of the enclosure to provide sealing.

Another aspect of the present disclosure relates to an IP 55 compliant sealing interface that includes mating sealing profiles made of the identical materials. In certain examples, the materials can include resins such as plastic resins. In certain examples, the materials can include a thermoplastic or a thermoset material. In certain examples, the material can include polymeric materials such as polycarbonate (PC), acrylonitrile-styrene-acrylate (ASA) and/or blends thereof. In certain examples, the plastic material can be relatively stiff so as to provide: a) enhanced mechanical protection; and b) robust sealing that can be repeatedly engaged and engaged over an extended time period without experiencing meaningful deterioration.

A further aspect of the present disclosure relates to an enclosure having jet stream redirecting structures that prevent spray from a water jet from being sprayed directly into the ingress path defined by a sealing interface.

Another aspect of the present disclosure relates to an enclosure in compliance with at least an IP 55 rating which is also ventilated.

A further aspect of the present disclosure relates to a sealing interface provided by an interference-fit between two plastic profiles which create pressure on the interface keeping it closed while concurrently including angled surfaces so that greater tolerances are allowed. In certain examples, the mating plastic profiles are interlocked by a snap-fit connection.

Still another aspect of the present disclosure relates to a sealing interface having first and second sealing regions separated by a pressure relief cavity from which liquid can drain via gravity. In certain examples, the pressure relief cavity is large enough to prevent jetted water that passes through the first sealing region from accumulating sufficient pressure to pass through the second sealing region. Instead, any water that enters the pressure relief cavity through the first sealing region simply drains from the cavity without passing through the second sealing region. In certain examples, sealing regions can be formed by interference seals or labyrinth seals. Interference seals are formed by surfaces that touch one another. Labyrinth seals are formed by surfaces that do not touch one another but are close enough together such that surface tension prevents water from passing between the surfaces. In certain examples, the seals can be referred to as contact seals and non-contact seals.

A further aspect of the present disclosure relates to an enclosure having a housing including a front cover piece and a rear base piece. The front cover piece is movable relative to the rear base piece between a closed position and an open position. The front cover piece engages with the rear base piece at a perimeter sealing interface when in the closed position. The front cover piece and the rear base piece cooperate to define an interior of the housing when the front cover piece is in the closed position. The interior of the housing is accessible when the front cover piece is in the open position. The housing has a major front side defined by the front cover piece and a major rear side defined by the rear base piece. The housing further includes a top side, a bottom side, a left side and a right side. The front cover piece is connected to the rear base piece and movable relative to the rear base piece between a closed position and an open position. The perimeter sealing interface extends along at least the left side, the top side and the right side of the housing. The bottom side of the housing can define an opening such as a cable entrance opening. The perimeter sealing interface includes a first sealing element unitarily formed with a main body of the front cover piece and a second sealing element unitarily formed with a main body of the rear base piece. The first sealing element defines a first sealing profile and the second sealing element defines a second sealing profile. The first and second sealing profiles engage when the front cover piece is in the closed position to provide inner and outer perimeter sealing regions separated by an expanded intermediate water pressure relief cavity. The intermediate water pressure relief cavity forms a channel having open drainage ends adjacent the bottom side of the housing for draining water that collects in the water pressure relief cavity.

Still another aspect of the present disclosure relates to an enclosure including a housing having a first housing piece and a second housing piece that mate together at a sealing interface to define an enclosed interior of the housing. The first housing piece includes a main body and a first perimeter sealing element unitarily formed with the main body of the first housing piece. The second housing piece includes a main body and a second perimeter sealing element unitarily formed with the main body of the second housing piece. The first sealing element defines a first sealing profile and the second sealing element defines a second sealing profile. The first and second sealing profiles interlock at the sealing interface when the first and second housing pieces are mated together. The interlocked first and second sealing profiles define an ingress path having an inner end adjacent the interior region of the housing and an outer end spaced from the inner end by a length of the ingress path. The first and second sealing profiles define inner and outer sealing regions and an expanded intermediate water pressure relief cavity positioned along the ingress path. The intermediate water pressure relief cavity is positioned between the inner and outer sealing regions. The outer end of the ingress path faces at least partially toward the main body of the first or second housing piece to limit its exposure to water jet streams. In certain examples, the enclosure can also include a barrier rib that projects from the main body of the first or second housing piece and that is positioned to prevent spray from a water jet from flowing along the main body to the outer end of the ingress path.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the examples disclosed herein are based.

### BRIEF DESCRIPTION OF THE DRAWINGS

FIG. 1 shows a re-enterable enclosure in accordance with the principles of the present disclosure in a closed position;

FIG. 2 depicts the enclosure of FIG. 1 in a partially open configuration;

FIG. 2A is an enlarged view of a first portion of FIG. 2;

FIG. 2B is an enlarged view of a second portion of FIG. 2;

FIG. 3 is a cross-sectional view of the enclosure of FIGS. 1 and 2 with the enclosure in a partially open position;

FIG. 4 is a cross-sectional view of the enclosure of FIGS. 1 and 2 in the closed position;

FIG. 5 is a cross-sectional view of sealing profiles of the enclosure of FIGS. 1 and 2 in a non-mated configuration;

FIG. 6 shows the sealing profiles of FIG. 5 in a mated configuration so as to form a sealing interface of the enclosure of FIGS. 1 and 2;

FIG. 7 shows the sealing profiles of FIG. 6 with an ingress path depicted;

FIG. 8 shows another set of sealing profiles in accordance with the principles of the present disclosure in a non-mated configuration, the sealing profiles are adapted for forming a perimeter sealing interface for a re-enterable enclosure such as the enclosure of FIGS. 1 and 2;

FIG. 9 shows the sealing profiles of FIG. 8 in a mated configuration so as to form a sealing interface;

FIG. 10 shows further sealing profiles in accordance with the principles of the present disclosure in a non-mated configuration, the sealing profiles are suitable for providing a sealing interface for a re-enterable enclosure such as the enclosure of FIGS. 1 and 2;

FIG. 11 shows the sealing profiles of FIG. 10 in a mated configuration so as to form a sealed interface;

FIG. 12 shows still further sealing profiles in accordance with the principles of the present disclosure in a non-mated configuration, the sealing profiles are adapted for forming a sealing interface for a re-enterable enclosure such as the enclosure of FIGS. 1 and 2;

FIG. 13 shows the sealing profiles of FIG. 12 in a mated configuration so as to form a sealed interface;

FIG. 14 shows another re-enterable enclosure in accordance with the principles of the present disclosure in a closed position;

FIG. 15 depicts the enclosure of FIG. 14 with a cover piece and base piece detached to show an interior of the enclosure;

FIG. 16 shows a back side of the enclosure of FIG. 14;

FIG. 17 is an enlarged portion of a bottom side of the base piece;

FIG. 18 is an enlarged portion of the bottom side of the base piece;

FIG. 19 shows a side view of the enclosure of FIG. 14;

FIG. 20 shows a cross-sectional view take along section P-P of the enclosure of FIG. 19;

FIG. 21 shows a top view of the enclosure of FIG. 14;

FIG. 22 shows a cross-sectional view taken along section J-J of the enclosure of FIG. 21;

FIG. 23 shows a cross-sectional view of a portion of the enclosure of FIG. 22;

FIG. 24 is an enlarged view of a portion of the enclosure shown in FIG. 23;

FIG. 25 shows a perspective cross-sectional view of a portion of the enclosure of FIG. 23;

FIG. 26 shows a cross-sectional view taken along section G-G of the enclosure of FIG. 21;

FIG. 27 shows a cross-sectional view taken along section H-H of the enclosure of FIG. 21;

FIG. 28 shows a cross-sectional view taken along section M-M of the enclosure of FIG. 21; and

FIG. 29 is an enlarged detail view N of a portion of the enclosure of FIG. 28.

### DETAILED DESCRIPTION

Aspects of the present disclosure relate to enclosures for housing components such as telecommunication components or electrical components. The enclosures include ingress protection so as to protect the internal electrical or telecommunications components from foreign materials such as dust and moisture. In certain examples, enclosures in accordance with the present disclosure are ventilated and also IP 55 rated. By “ventilated”, it is meant that the enclosure provides suitable ingress protection with respect to materials such as water and dust while not being completely airtight. In certain examples, enclosures in accordance with the principles of the present disclosure provide ingress protection without requiring the use of separate elastomeric sealing (e.g., rubber-like O-ring or other type of elastomeric seal). In this way, in certain examples, the enclosure can be made of only one type of material which lowers the need for inventory and resource planning (e.g., fewer machine change-overs, time and process control gains, enhanced material stocking efficiency, etc.) and has ecological benefits (e.g., no mixture of production wastes, no end-of-life separation of materials, etc.) Additionally, since many elastomers such as rubbers have time-dependent characteristics, sealing interfaces in accordance with the principles of the present disclosure can improve the long-term behavior and life of re-enterable enclosures in certain environments. Still other examples of the present disclosure can have enclosures with housing pieces having integral/unitary sealing profiles that can be manufactured using relatively simple open or closed molding techniques.

In this disclosure, sealing profiles are described. As used herein, a “sealing profile” is the shape of a sealing element when viewed in transverse cross-section.

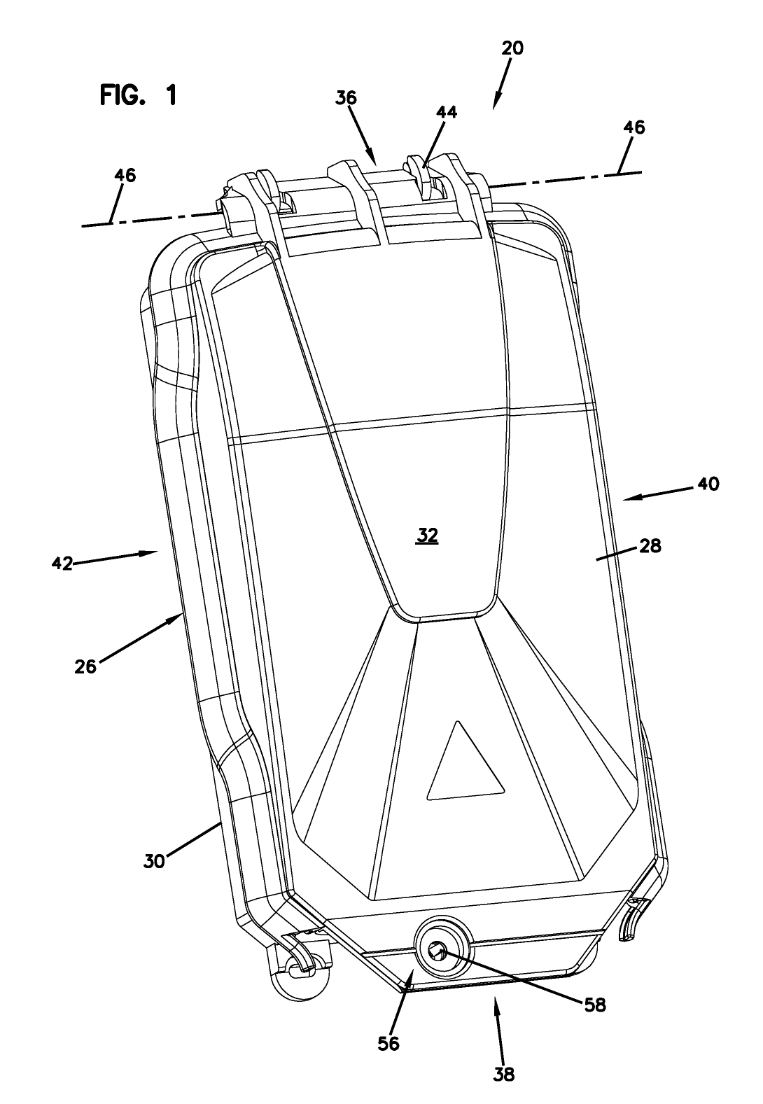

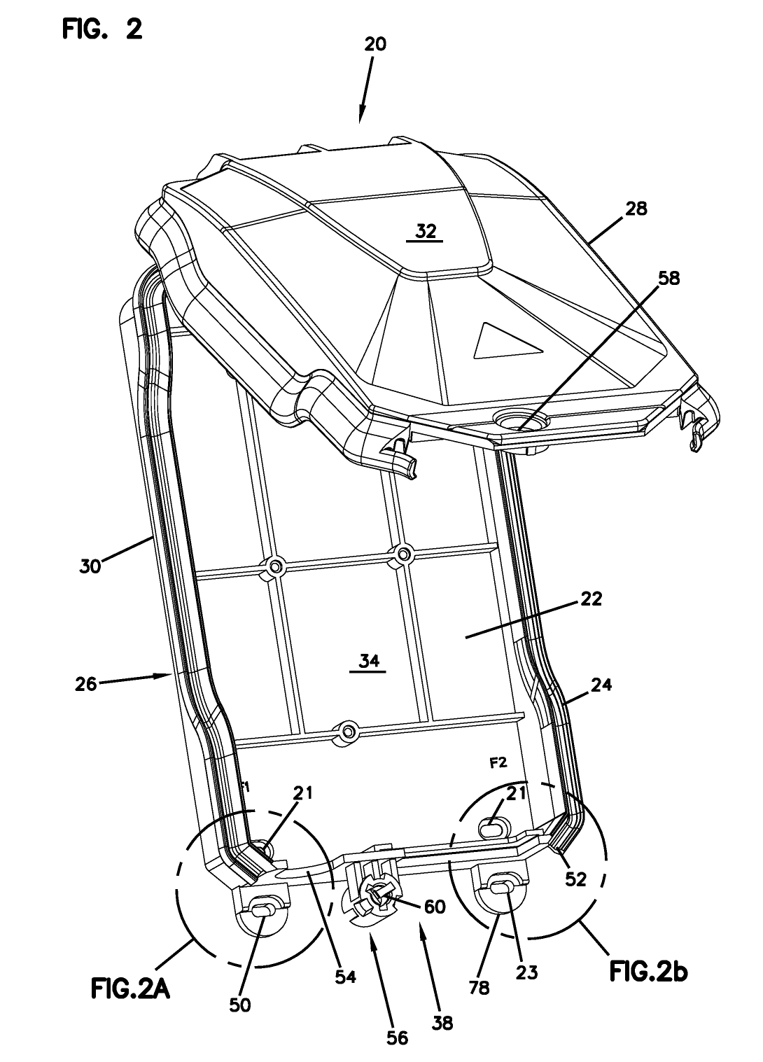

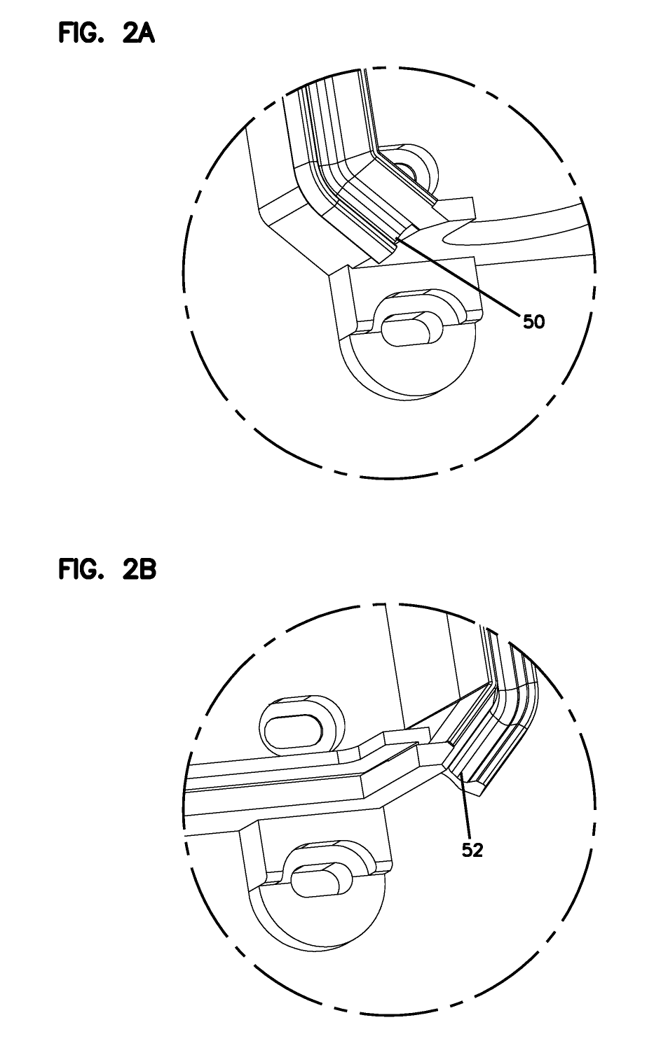

FIGS. 1 and 2 illustrate an enclosure 20 in accordance with the principles of the present disclosure. The enclosure 20 is preferably configured for protecting components (e.g., electrical components or telecommunications components such as optical fibers, fiber optic splices, fiber optic splice trays, passive optical splitters, wavelength division multiplexers, or other structures) from foreign materials such as dirt, dust, and water. In a preferred example, the enclosure 20 is re-enterable so that the enclosure 20 can be selectively opened and closed so as to provide access to an interior region 22 of the enclosure 20 in which the components desired to be protected are housed. It will be appreciated that the enclosure 20 can include a sealing interface 24 that is mated (i.e., interlocked) to provide ingress protection when the enclosure 20 is in a closed position (as shown at FIG. 1) and that is de-mated or de-coupled when the enclosure 20 is in an open configuration (e.g., see FIG. 2). It will be appreciated that the sealing interface 24 can include sealing elements (i.e., sealing features) unitarily formed with main housing bodies of the enclosure 20. Thus, in certain examples, the sealing features can be made of a relatively stiff, plastic material. In certain examples, the sealing features are relatively robust and are able to withstand many opening and closing cycles of the enclosure 20 without experiencing meaningful degradation. In certain examples, the enclosure 20 is a ventilated enclosure that provides ingress protection rated to at least an IP 55 level.

Referring again to FIGS. 1 and 2, the enclosure 20 includes a housing 26 including a front cover piece 28 and rear base piece 30. It will be appreciated that the front cover piece 28 and the rear base piece 30 can also be referred to generally as housing pieces, first housing pieces, second housing pieces or like terms. The front cover piece 28 is movable relative to the rear base piece 30 between a closed position (see FIG. 1) and an open position (see FIG. 2). The front cover piece 28 mates with the rear base piece 30 at the perimeter sealing interface 24 when the front cover piece 28 is in the closed position. The front cover piece 28 and the rear base piece 30 cooperate to define the interior region 22 of the housing 26 when the front cover piece 28 is in the closed position. The interior region 22 of the housing 26 is accessible when the front cover piece 28 is in the open position.

The housing 26 includes a major front side 32 defined by the front cover piece 28 and a major rear side 34 defined by the rear base piece 30. The housing 26 further includes a top side 36, a bottom side 38, a left side 40 and a right side 42. The front cover piece 28 is pivotally connected to the rear base piece 30 by a hinge 44 at the top side 36 of the housing 26. The hinge 44 allows the front cover piece 28 to be pivoted relative to the rear base piece 30 about a pivot axis 46 between the open and closed positions. The sealing interface 24 extends along at least the left side 40, the top side 36, and the right side 42 of the housing 26. In one example, the sealing interface 24 extends from a first drainage opening 50 located at a bottom right corner of the housing 26 continuously up the right side 42 of the housing 26, across the top side 36 of the housing 26, and down the left side 40 of the housing 26 to a second drainage opening 52 located at a bottom left corner of the housing 26.

In certain examples, the sealing interface 24 does not extend across the bottom side 38 of the housing 26. In certain examples, at least one opening 54 (i.e., a pass-through opening, a cable opening, etc.) can be defined at the bottom side 38 of the housing 26. The opening 50 can be configured for routing structures such as telecommunications cables or electrical cables into the interior region 22 of the housing 26. In certain examples, the opening 54 can include a “wrap-around” configuration in which the opening 54 has an open side when the front cover piece 28 is open. Such a “wrap-around” configuration allows a cable to be inserted into the axis opening 54 from the front side of the rear base piece 30 and does not require the cable to be threaded axially through the opening as would be the case when a fully enclosed pass-through opening is utilized. In other examples, the opening 54 may be fully enclosed. Additionally, more than one opening 54 may be provided at the bottom side of the housing 26.

In certain examples, the sealing interface 24 can include sealing features that flex elastically and snap together when the front cover piece 28 is moved to the closed position. Thus, the sealing interface 24 can provide the dual function of: a) providing ingress protection; and b) mechanically retaining the front cover piece 28 in the closed position relative to the rear base piece 30. In other examples, an additional latch or latches can be provided for retaining the front cover piece 28 in the closed position. As depicted in the example of FIGS. 1 and 2, a latching arrangement 56 can be provided adjacent the bottom side 38 of the housing 26. The latching arrangement 56 can include a fastener opening 58 defined by the front cover piece 28 that receives a fastener that also engages with a receptacle 60 defined by the rear base piece 30 to retain the front cover piece 28 in the closed position. Example fasteners include bolts, screws, cams, bayonet style fittings, latches or other structures.

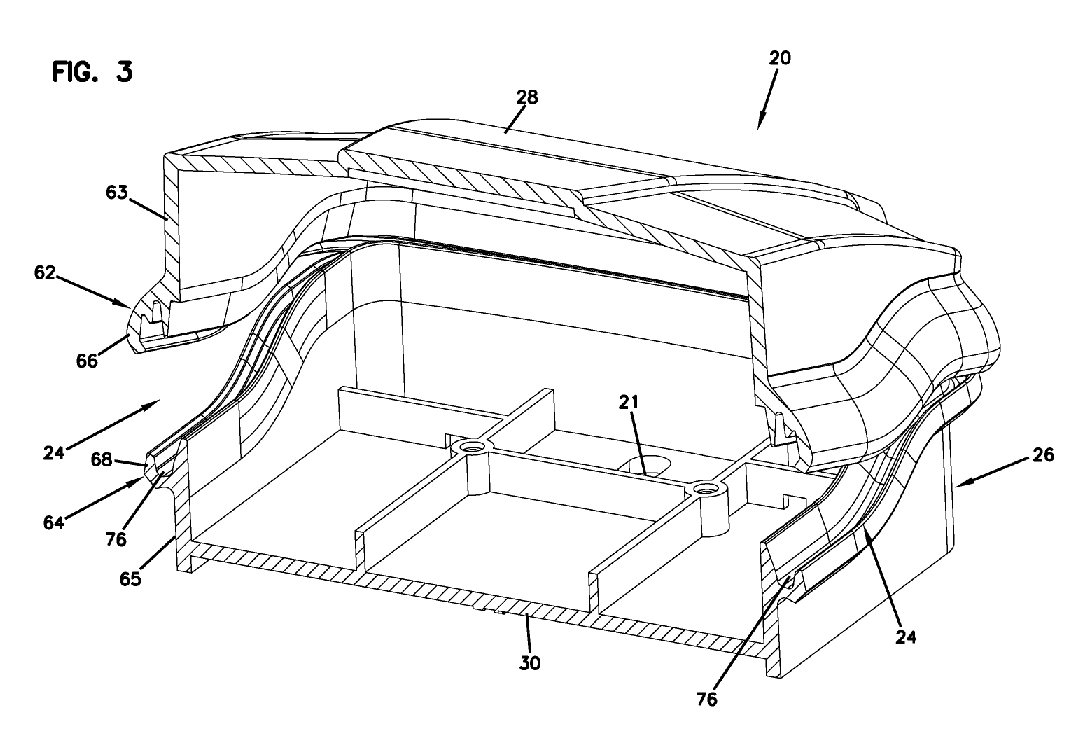

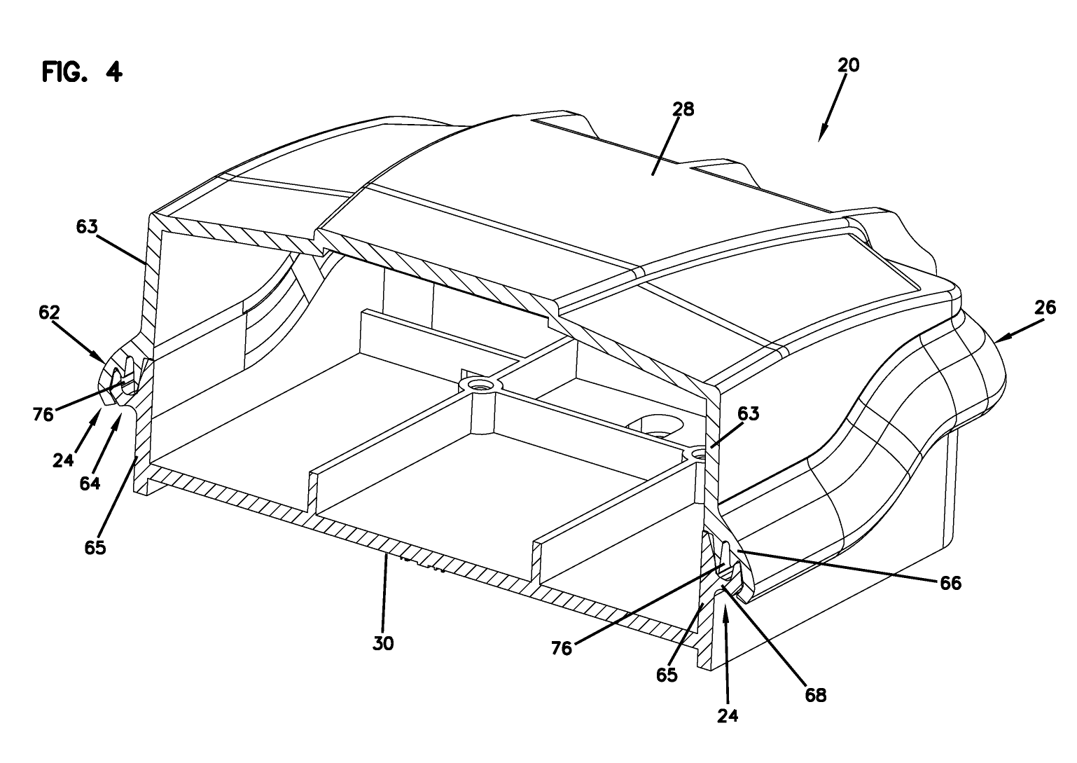

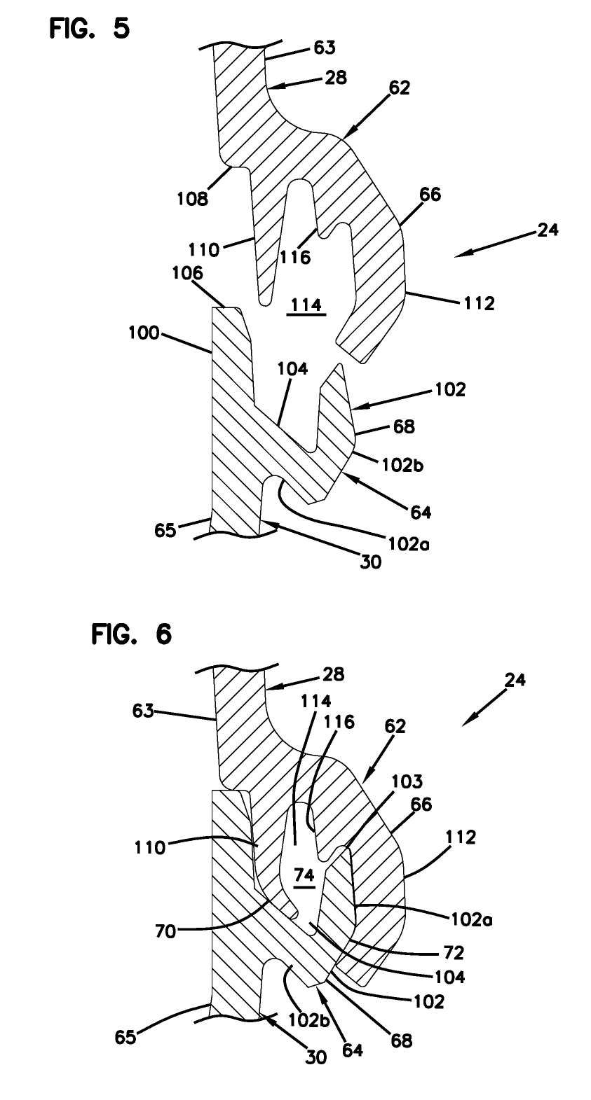

Referring to FIGS. 3 and 4, the perimeter sealing interface 24 extends around at least a majority of the perimeter of the housing 26 and includes a first sealing element 62 unitarily formed with a main body 63 of the front cover piece 28 and a second sealing element 64 unitarily formed with a main body 65 of the rear base piece 30. The first sealing element 62 defines a first sealing profile 66 and the second sealing element 64 defines a second sealing profile 68 configured to interlock with the first sealing profile 66 when the housing 26 is in the closed configuration. FIG. 5 shows the first and second sealing profiles 66, 68 prior to being interlocked with one another. FIG. 6 shows the first and second sealing profiles 66, 68 interlocked together. It will be appreciated that various features (e.g., fingers, flanges, projections, receptacles) of the first and second sealing profiles 66, 68 elastically flex as the first and second sealing profiles 66, 68 are interlocked. In one example, the first sealing profile 66 includes at least a portion that snaps over the second sealing profile 68 to provide a snap-fit connection between the first and second sealing profiles 66, 68 that mechanically retains the first and second sealing profiles 66, 68 in the interlocked position.

Referring to FIG. 6, when the first and second sealing profiles 66, 68 are interlocked, the first and second sealing profiles 66, 68 of the sealing interface 24 provide an inner sealing region 70 and an outer sealing region 72 separated by an expanded intermediate water pressure relief cavity 74. The intermediate water pressure relief cavity 74 forms a drainage channel 76 (see FIG. 4) that extends from the first drainage opening 50 continuously up the right side 52 of the housing 26, across the top side 36 of the housing 26, and down the left side 40 of the housing 26 to the second drainage opening 52. The drainage channel 76 allows any water that collects in the intermediate water pressure relief cavity 74 to drain from the sealing interface 24 via gravity out the first and second drainage openings 50, 52.

In certain examples, no elastomeric sealing elements such as a rubber O-ring or other like structure are provided between the first and second sealing profiles 66, 68. Additionally, in certain examples, the first sealing element 62 and the second sealing element 64 are constructed of identical materials.

In certain examples, inner sealing region 70 can include either a contact-type seal such as a seam formed by interference between the first and second sealing profiles 66, 68 or a non-contact seal such as a labyrinth seal formed between the first and second sealing profiles 66, 68. Similarly, the outer sealing region 72 can be formed by a contact-type seal such as a seam formed by interference between the first and second sealing profiles 66, 68 or a non-contact seal such as a labyrinth seal formed between the first and second sealing profiles 66, 68.

It will be appreciated that during ingress protection testing, a water jet can be sprayed at the exterior of the housing 26. Under certain conditions, it may be possible for some water to pass through the outer sealing region 72 into the intermediate water pressure relief cavity 74. In this regard, it is preferred for the intermediate water pressure relief cavity 74 to have a transverse cross-sectional area that is sufficiently large such that any water passing through the outer sealing region 72 is de-pressurized so that the intermediate water pressure relief cavity 74 is maintained generally at atmospheric pressure. In this way, the intermediate water pressure relief cavity 74 prevents significant water pressure from being applied to the exterior side of the inner sealing region 70. In this way, the inner sealing region 70 provides better resistance to water intrusion. It will be appreciated that the exact transverse cross-sectional sizes of the intermediate water pressure relief cavity 74 is dependent upon the effectiveness of the outer sealing region 72 and variations in the test environment. However, in one non-limiting example, the intermediate water pressure relief cavity 74 can have a transverse cross-sectional area of at least 2 square millimeters.

As indicated above, the first and second sealing elements 62, 64 can be unitarily formed with their corresponding housing pieces. Thus, in certain examples, the first and second sealing elements 62, 64 can be made of relatively hard material suitable for providing mechanical protection (e.g., impact resistance, shock resistance, etc.). Example materials include plastic materials such as thermoplastic material or thermoset material. In certain examples, the material can include amorphous polymers. One example material can include polycarbonate (PC). Another example material can include acrylonitrile-styrene-acrylate (ASA). Other example materials can include blends or composites of any of the above materials. In certain examples, the materials can be UV-resistant. In certain examples, the materials can be low-smoke zero-halogen (LSZH) resins. In one example, the materials can exhibit a tensile modulus higher than 1800 megapascals (MPa), with a loading speed of 1 millimeter per minute, as tested according to the ISO 527 standard established by the International Organization for Standardization.

In certain examples, the enclosure 20 can be adapted to be mounted to a structure such as a wall, pole or other structure. In this regard, the housing 26 can include fastener openings used to receive fasteners for securing the enclosure 20 to a structure. It will be appreciated that the housing 26 can define fastener openings 21 defined through the major rear side 34 of the rear base piece 30. Additionally, fastener openings 23 can be defined by tabs 78 located at the bottom side 38 of the housing 26.

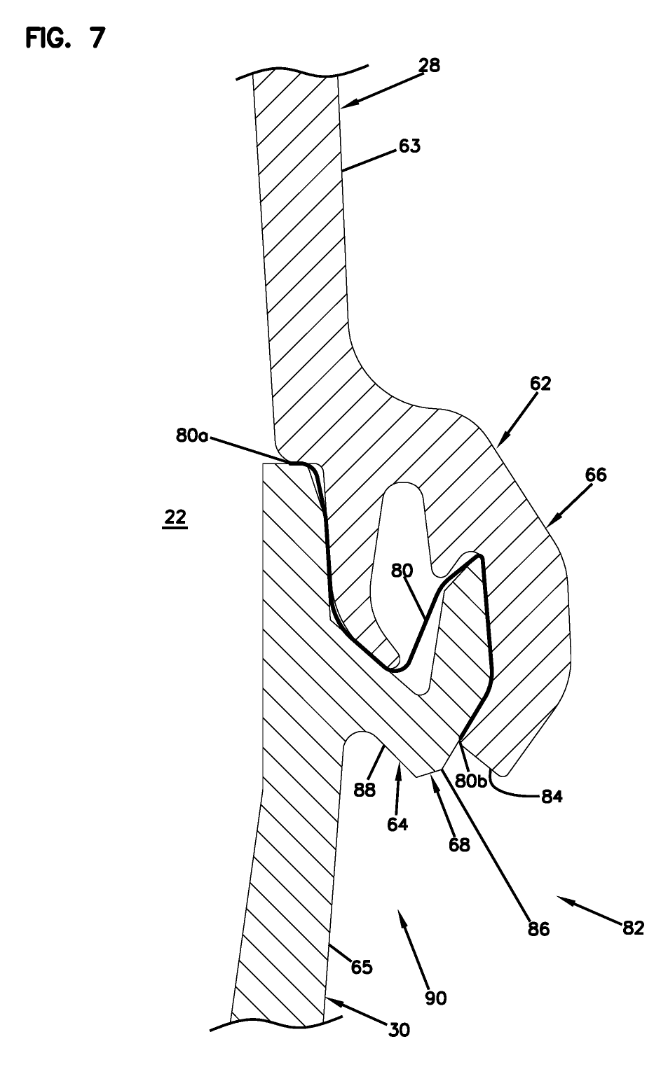

Referring to FIG. 7, the first and second sealing profiles 66, 68 can define an ingress path 80 having an inner end 80a adjacent the interior region 22 of the housing 26 and an outer end 80b spaced from the inner end 80a by a length of the ingress path 80. The inner sealing region 70, the intermediate water pressure relief cavity 74 and the outer sealing region 72 are positioned consecutively along the ingress path 80 as the ingress path 80 extends from the inner end 80a to the outer end 80b. The first and second sealing profiles 66, 68 are configured such that the outer end 80b of the ingress path 80 faces at least partially toward the main body 65 of the rear base piece 30. This type of arrangement is advantageous because by facing the outer end 80b of the ingress path 80 toward the main body of the housing 26, it is more difficult for a water jet to be aimed directly at the outer end 80b of the ingress path 80. In other words, by facing the outer end 80b of the ingress path 80 toward the main body of the housing, interference with the main body of the housing 26 prevents a nozzle of the water jet from being positioned to direct a water stream directly at the outer end 80b of the ingress path 80. Water jets directed generally at a side of the housing 26 (e.g., see direction 82) would not result in pressurized water being forced directly into the ingress path 80.

As shown at FIG. 7, the outer sealing region 72 extends generally to a free end 84 of the first sealing element 62. The outer end 80b (i.e., the entrance end) of the ingress path 80 is located at the free end 84 of the first sealing element 62.

Referring still to FIG. 7, the housing 26 also includes structure that prevents a water jet directed at the left side, right side, or top side of the housing 26 from being deflected into the outer end 80b of the ingress path 80. For example, the rear base piece 30 can include a barrier rib 86 that projects outwardly from the main body 65 of the rear base piece 30. The barrier rib 86 is positioned to prevent spray from a water jet from flowing along the main body 63 to the outer end 80b of the ingress path 80. For example, a water jet spray directed along direction 90 deflects forwardly along the main body 65 of the rear base piece 30 until the stream impacts the barrier rib 86. The barrier rib 86 deflects the stream rearwardly and outwardly away from the outer end 80b of the ingress path 80. In certain examples, the barrier rib 86 can include a spray deflection surface 88 oriented at an acute angle with respect to the main body 65 of the rear base piece 30.

Referring back to FIGS. 5 and 6, the second sealing profile 68 includes an inner finger 100 and an outer finger 102 that cooperate to define a pocket 104 having an open side that faces in a forward direction. The inner finger 100 includes an end 106 adapted to abut against a shoulder 108 of the first sealing profile 66 when the first and second sealing profiles 66, 68 are interlocked. The outer finger 102 includes a first portion 102a that projects outwardly and rearwardly from the inner finger 100, and a second portion 102b that extends forwardly from an outer end of the first portion 102a. The first sealing profile 66 includes an inner finger 110 and an outer finger 112 that cooperate to define a pocket 114 that faces in a rearward direction. The inner and outer fingers 110, 112 both extend generally rearwardly from the main body 63 of the front cover piece 28. The first sealing profile 66 also includes an intermediate finger 116 that projects into the pocket 114. When the first and second sealing profiles 66, 68 are mated together, the inner finger 110 of the first sealing profile 66 flexes against an outer surface of the inner finger 100 of the second sealing profile 68 and a forward surface of the outer finger 102 of the second sealing profile 68. Thus, the inner finger 110 fits within the pocket 104. The contact between the finger 110 and the fingers 100, 102 provides the inner sealing region 70. Additionally, the outer finger 112 of the first sealing profile 66 snaps over the forwardly extending portion 102b of the outer finger 102 of the second sealing profile 68 and a tip of the outer finger 102 fits within a sub-pocket 103 defined between the intermediate finger 116 and the outer finger 112 of the first sealing profile 66. The sub-pocket 103 is within the pocket 114. Contact between the inner side of the outer finger 112 of the first sealing profile 66 and the outer side of the finger 102 of the second sealing profile 68 provides the outer sealing region 72. The pockets 104, 114 cooperate to define the water pressure relief cavity 74 between the inner and outer sealing regions 70, 72.

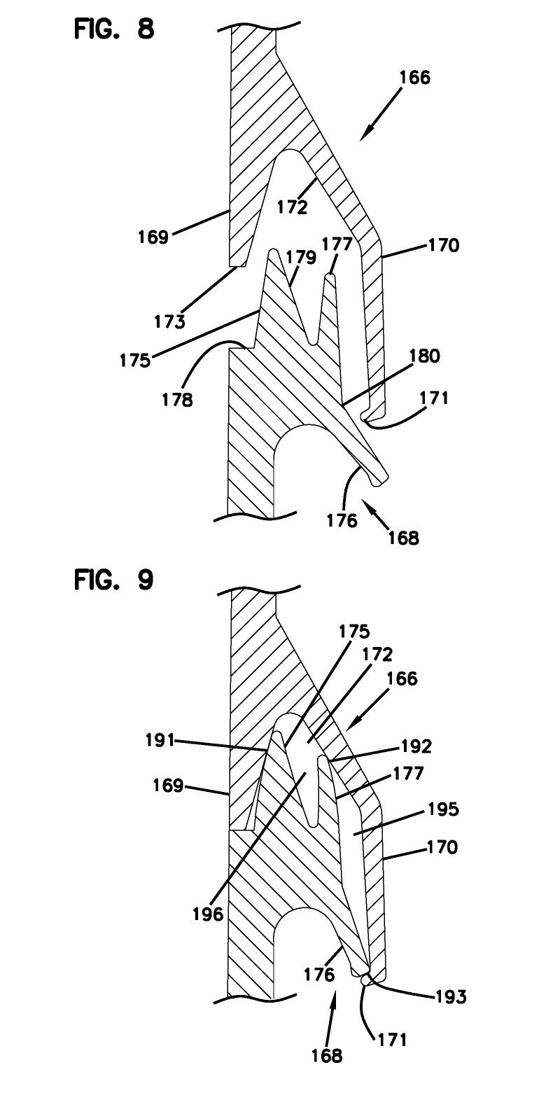

FIGS. 8 and 9 show additional first and second sealing profiles 166, 168 in accordance with the principles of the present disclosure. The first sealing profile includes an inner finger 169 and an outer finger 170. The outer finger 170 includes an inwardly extending tip 171. The fingers 169, 170 cooperate to define a pocket 172 that faces in a rearward direction. The finger 169 has an end defining a stop surface 173. The second sealing profile 168 includes an inner finger 175, an outer finger 176 and an intermediate finger 177. The inner finger 175 and the intermediate finger 177 extend generally in a forward direction. The outer finger 176 is angled in a rearward and outward direction. The second sealing profile 168 also includes a stop surface 178. A pocket 179 is defined between the inner finger 175 and the intermediate finger 177. The pocket 179 faces in a forward direction. Additionally, a pocket 180 is defined between the intermediate finger 177 and the outer finger 176. The pocket 180 faces in a lateral direction. When the first and second sealing profiles 166, 168 are mated together, the stop surface 173 engages the stop surface 178. Additionally, the inner finger 175 and the intermediate finger 177 fit within the pocket 172 with the inner finger 175 engaging the inner finger 169 to form a first sealing region 191 and the finger 177 engaging the finger 170 to form second sealing region 192. A third sealing region 193 is defined between the finger 176 and the inward extension 171 of the finger 170. The sealing interface of FIGS. 7 and 8 has three sealing regions 191, 192 and 193 and two water pressure relief cavities 195, 196.

As indicated above, the sealing region 193 is defined between the finger 170 and the finger 176 and has an outer end that faces toward the main body of the housing. The sealing region 192 is defined between the finger 177 and the finger 170. The water pressure relief cavity 196 is defined between the sealing region 191 and the sealing region 192. The first sealing region 191 is defined between the finger 175 and the finger 169. The water pressure relief cavity 195 is defined between the third sealing region 193 and the second sealing region 192. It will be appreciated that the finger 170 flexes over the finger 176 to provide a snap-fit mechanical connection that assists in retaining the first and second sealing profiles 166, 168 in the mated orientation.

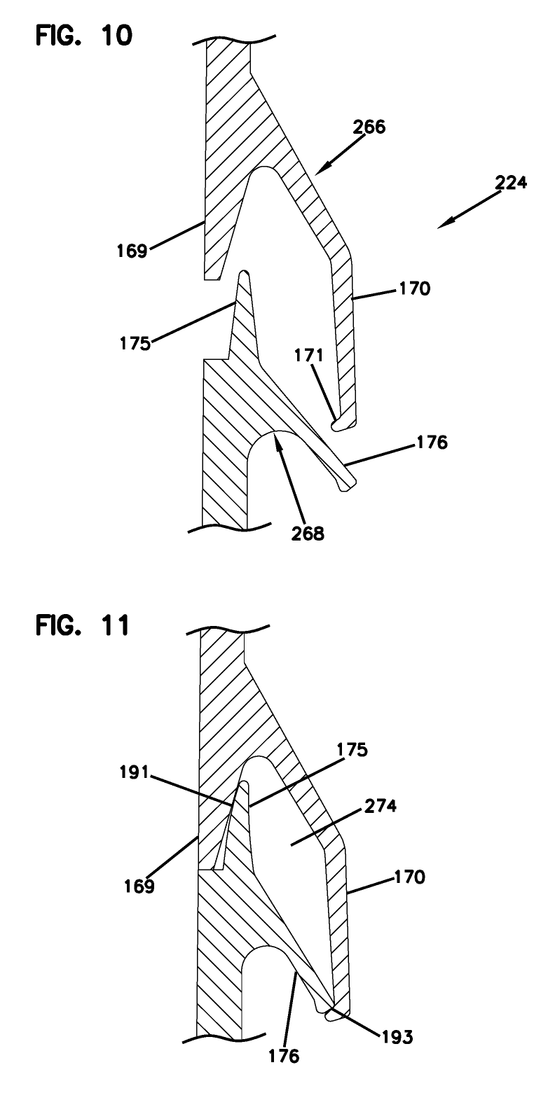

FIGS. 10 and 11 show a further sealing interface 224 in accordance with the principles of the present disclosure. The sealing interface 224 includes a first sealing profile 266 and a second sealing profile 268. The first sealing profile 266 is the same as the first sealing profile 166. The second sealing profile 268 is similar to the second sealing profile 168 except the intermediate finger 177 has been eliminated. Because of the similarity of the parts, the various fingers of the first and second sealing profiles 266, 268 have been assigned the same reference numbers used with respect to the first and second sealing profiles 166, 168. In the example FIGS. 9 and 10, the outer finger 170 snaps over the outer finger 176. One water pressure relief cavity 274 is defined between first and third sealing regions 191 and 193.

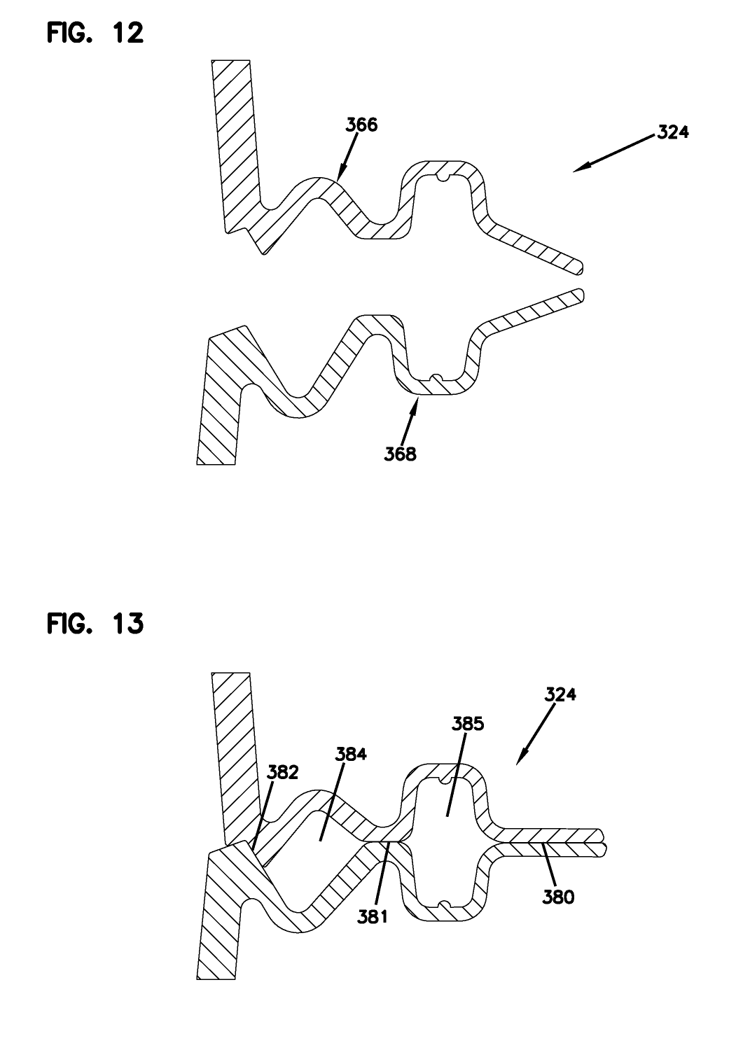

FIGS. 12 and 13 illustrate still another sealing interface 324 in accordance with the principles of the present disclosure. The sealing interface 324 includes first and second sealing profiles 366, 368. Unlike the previously described examples, the first and second sealing profiles 366, 368 do not interlock via a snap-fit connection. Instead, the first and second sealing profiles 366, 368 are merely pressed together and caused to elastically to form. It will be appreciated that additional clamps or fasteners can be used with the enclosure to hold the first and second sealing profiles 366, 368 mated together. When the first and second sealing profiles 366, 368 are mated together as shown at FIG. 12, the sealing interface 324 provides three sealing regions 380, 381, and 382. A first water pressure relief cavity 384 is defined between the sealing regions 381 and 380, and a second water pressure relief cavity 385 is defined between the sealing regions 381 and 382. The outer ends of the first and second sealing profiles 366, 368 are biased together to form the sealing region 380. It will be appreciated that the ends of the first and second sealing profiles 366, 368 can flex in a forward direction or a rearward direction when exposed to a water stream so that the water stream is prevented from being directed directly into the sealing region 380.

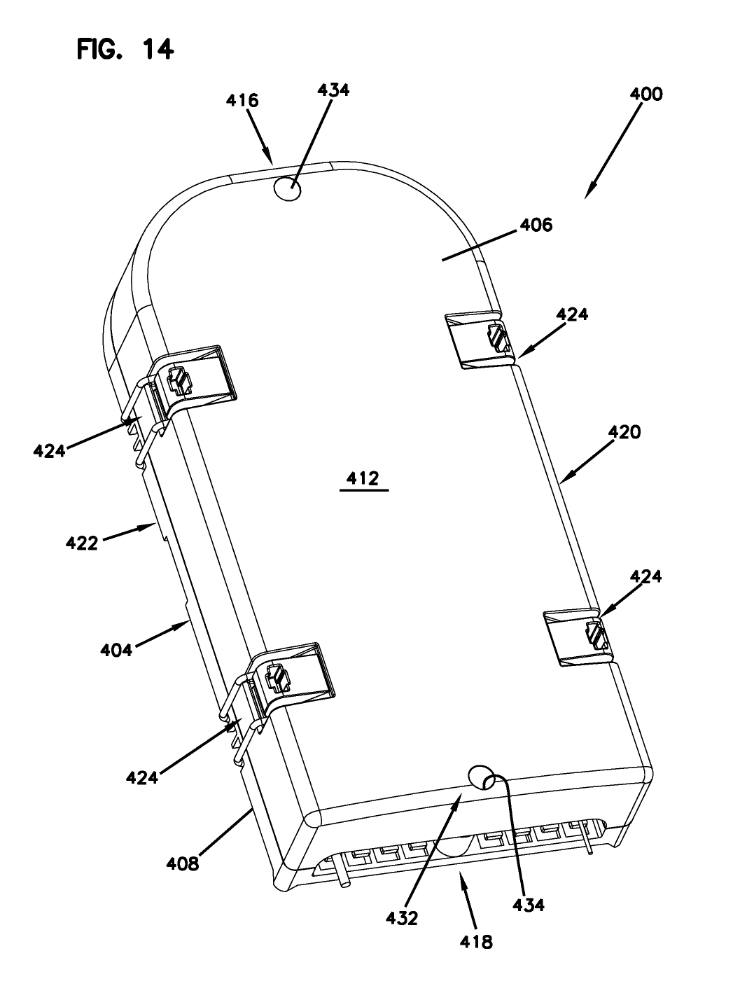

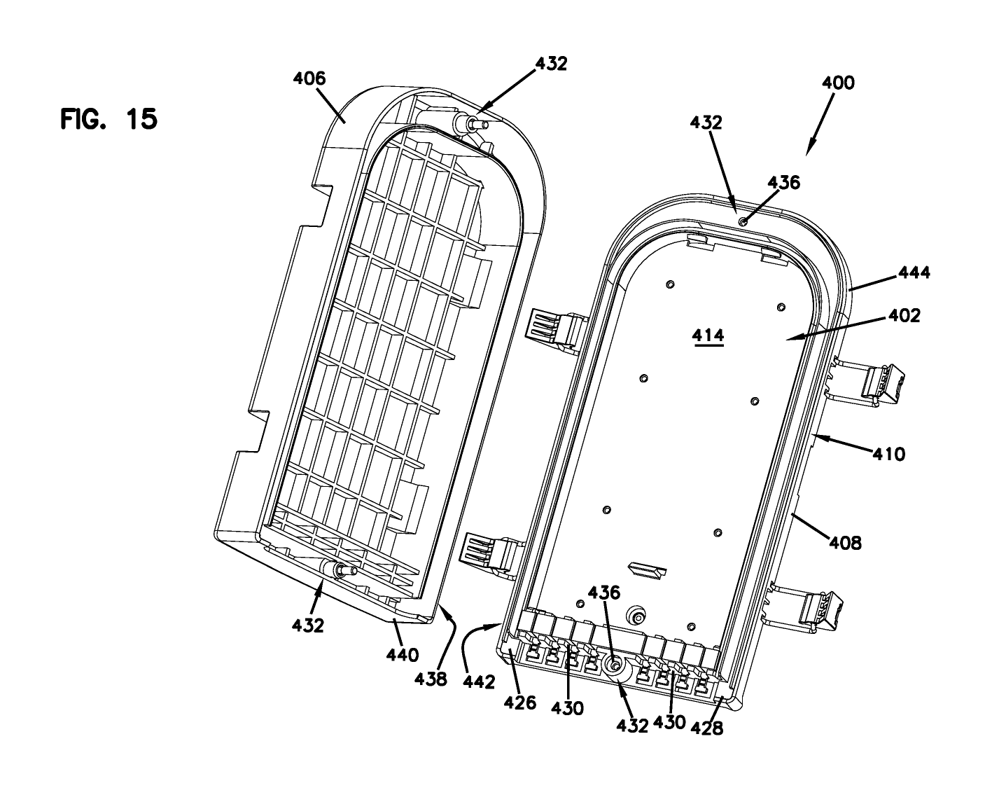

FIGS. 14 and 15 illustrate another enclosure 400 in accordance with the principles of the present disclosure. The enclosure 400 can be configured for protecting components (e.g., electrical components or telecommunications components such as optical fibers, fiber optic splices, fiber optic splice trays, passive optical splitters, wavelength division multiplexers, or other structures) from foreign materials such as dirt, dust, and water. In a preferred example, the enclosure 400 is re-enterable so that the enclosure 400 can be selectively opened and closed so as to provide access to an interior region 402 (see FIG. 15) of the enclosure 400 in which the components desired to be protected are housed.

The example enclosure 400 includes a housing 404 including a front cover piece 406 and rear base piece 408. It will be appreciated that the front cover piece 406 and the rear base piece 408 can also be referred to generally as housing pieces, first housing pieces, second housing pieces or like terms. The front cover piece 406 is movable relative to the rear base piece 408 between a closed position (see FIG. 14) and an open position (see FIG. 15).

It will be appreciated that the enclosure 400 can include a perimeter sealing interface 410 that is engaged to provide ingress protection when the enclosure 400 is in a closed position (as shown at FIG. 14) and that is disengaged or de-coupled when the enclosure 400 is in an open configuration (e.g., see FIG. 15). It will be appreciated that the sealing interface 410 can include sealing elements (i.e., sealing features) unitarily formed with main housing bodies of the enclosure 400. Thus, in certain examples, the sealing features can be made of a relatively stiff, plastic material. In certain examples, the sealing features are relatively robust and are able to withstand many opening and closing cycles of the enclosure 400 without experiencing meaningful degradation. In certain examples, the enclosure 400 is a ventilated enclosure that provides ingress protection rated to at least an IP 55 level.

The front cover piece 406 engages with the rear base piece 408 at the perimeter sealing interface 410 when the front cover piece 406 is in the closed position. The front cover piece 406 and the rear base piece 408 cooperate to define the interior region 402 of the housing 404 when the front cover piece 406 is in the closed position. The interior region 402 of the housing 404 is accessible when the front cover piece 406 is in the open position.

The housing 404 includes a major front side 412 defined by the front cover piece 406 and a major rear side 414 defined by the rear base piece 408. The housing 404 further includes a top side 416, a bottom side 418, a left side 420 and a right side 422. The front cover piece 406 is connected to the rear base piece 408 by clip arrangements 424 (e.g., clamps, latches, etc.) arranged around a perimeter of the front cover piece 406 and the rear base piece 408. In the depicted example, a total of four clip arrangements 424 are shown, although alternatives are possible.

It will be appreciated that other securing mechanisms may be used to connect the front cover piece 406 to the rear base piece 408. For example, the front cover piece 406 may be pivotally connected to the rear base piece 408 by a hinge, although alternatives are possible. For example, the front cover piece 406 may be connected to the rear base piece 408 by a snap-fit connection.

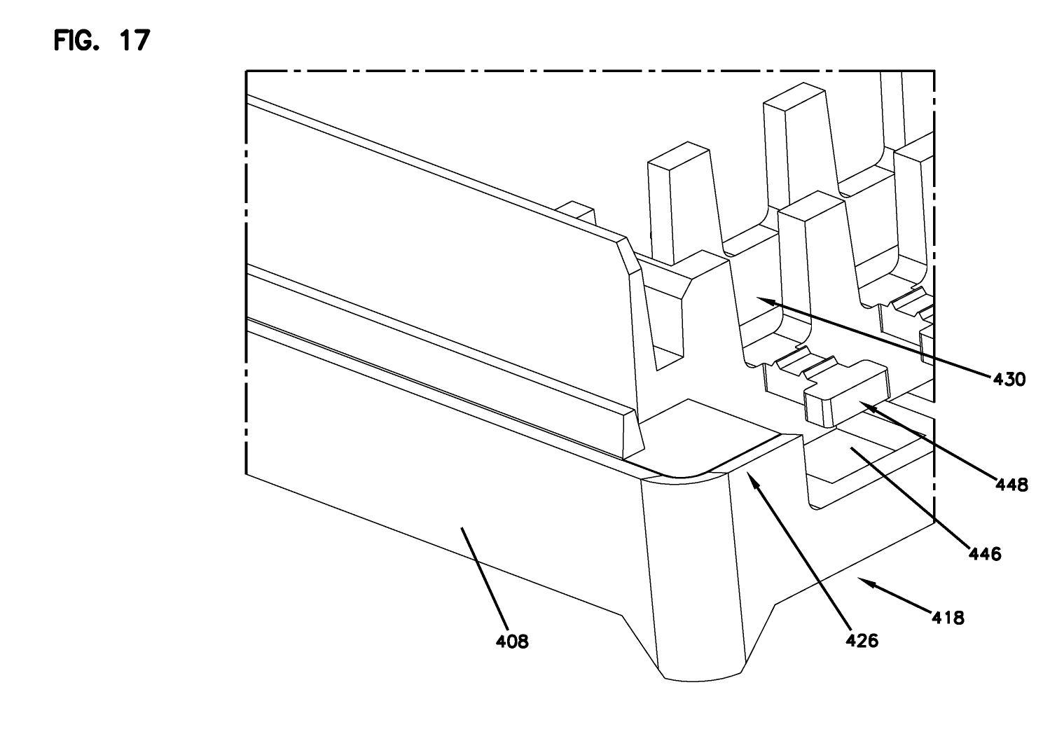

The perimeter sealing interface 410 extends along at least the left side 420, the top side 416, and the right side 422 of the housing 404. In one example, the perimeter sealing interface 410 extends from a first drainage opening 426 (see FIG. 17) located at a bottom right corner of the housing 404 continuously up the right side 422 of the housing 404, across the top side 416 of the housing 404, and down the left side 420 of the housing 404 to a second drainage opening 428 (see FIG. 15) located at a bottom left corner of the housing 404.

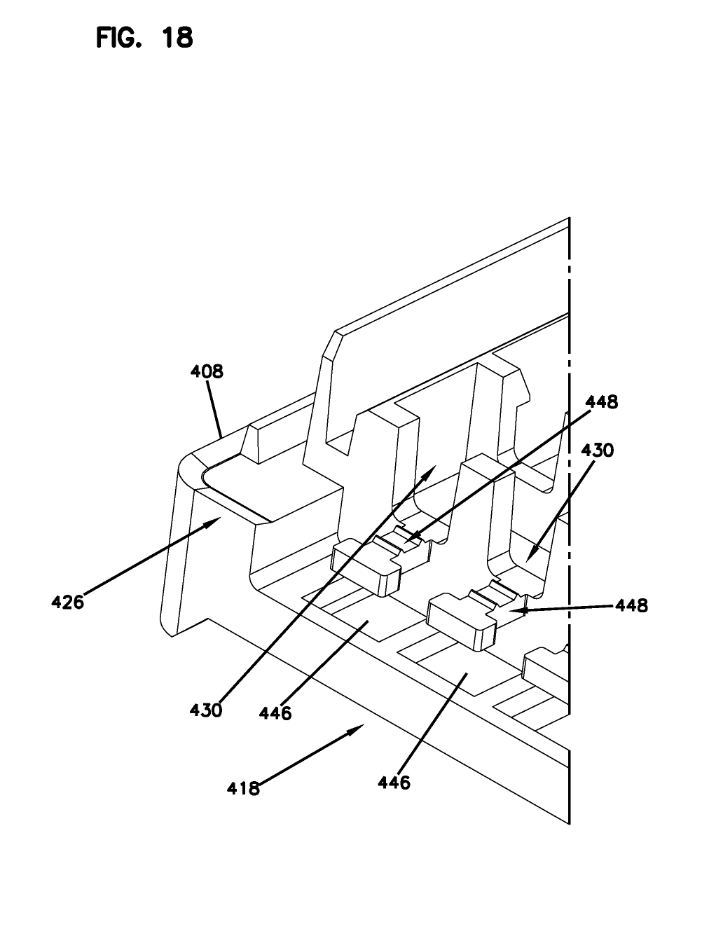

In certain examples, the perimeter sealing interface 410 does not extend across the bottom side 418 of the housing 404. Referring to FIGS. 17 and 18, at least one opening 430 (i.e., a pass-through opening, a cable opening, etc.) can be defined at the bottom side 418 of the housing 404. The opening 430 can be configured for routing structures such as telecommunications cables or electrical cables into the interior region 402 of the housing 404. In certain examples, the opening 430 can include a “wrap-around” configuration in which the opening 430 has an open side when the front cover piece 406 is open. Such a “wrap-around” configuration allows a cable to be inserted into the axis opening 430 from the front side of the rear base piece 408 and does not require the cable to be threaded axially through the opening 430 as would be the case when a fully enclosed pass-through opening is utilized. In other examples, the opening 430 may be fully enclosed. Additionally, more than one opening 430 may be provided at the bottom side 418 of the housing 404.

In certain examples, the cable can be anchored to the rear base piece 408 using a tie 433 (e.g., zip tie, etc.) that can be secured through tie down locations 446 (e.g., openings) defined in the rear base piece 408 at the bottom side 418 of the housing 404. The tie 433 can wrap around support members 448 of the rear base piece 408 to anchor the cable.

In certain examples, the perimeter sealing interface 410 can include sealing features that flex elastically when the front cover piece 406 is moved to the closed position. Thus, the perimeter sealing interface 410 can provide the dual function of: a) providing ingress protection; and b) mechanically retaining the front cover piece 406 in the closed position relative to the rear base piece 408.

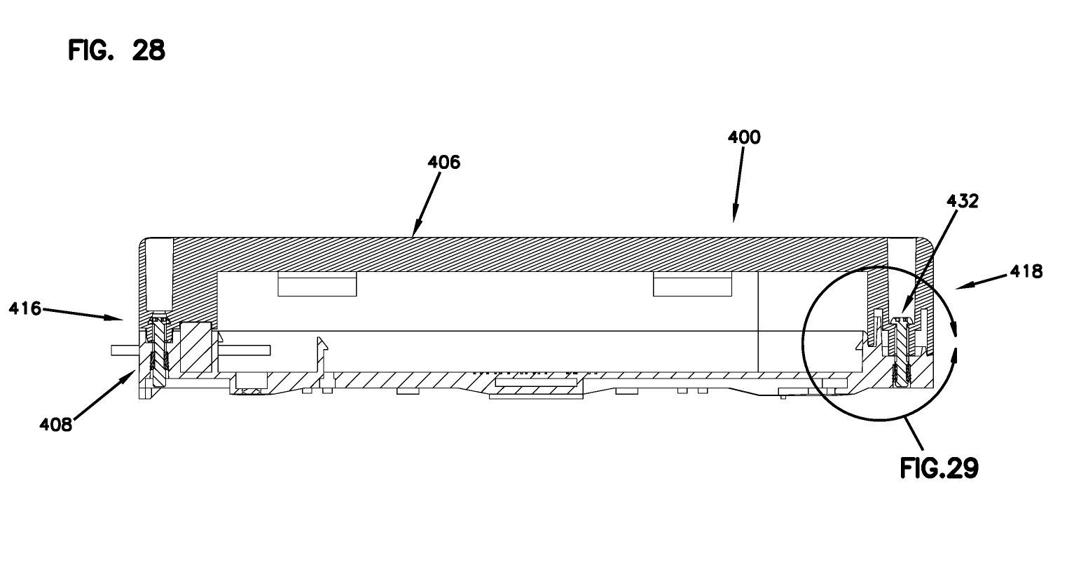

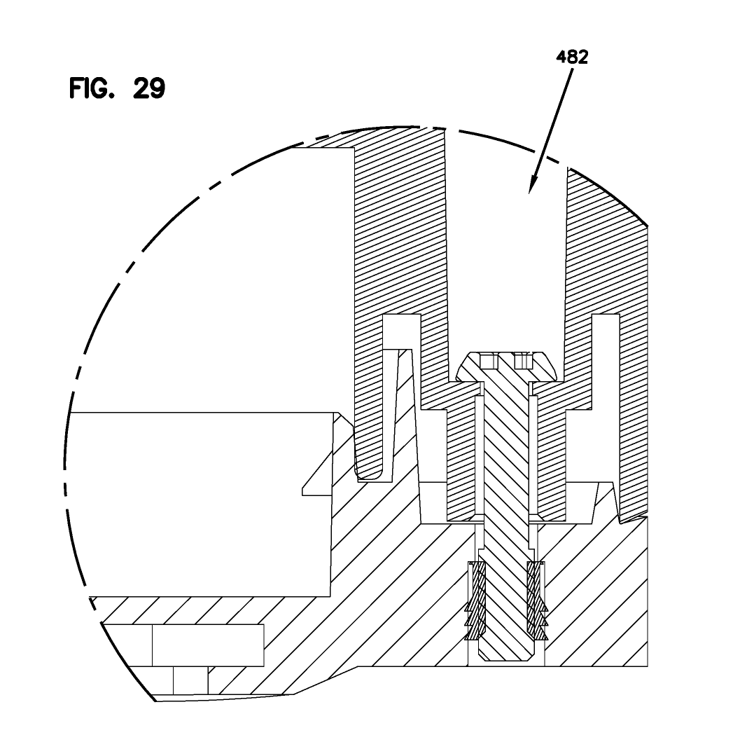

Turning again to the example shown in FIGS. 14 and 15, a latching arrangement 432 can be provided adjacent the bottom side 418 of the housing 404. In certain examples, the latching arrangement 432 can also be provided adjacent the top side 416 of the housing 404. A cross-sectional view of the latching arrangement 432 is shown in FIGS. 28 and 29. The latching arrangement 432 can include a fastener opening 434 defined by the front cover piece 406 that receives a fastener that also engages with a receptacle 436 defined by the rear base piece 408 to retain the front cover piece 406 in the closed position. Example fasteners include bolts, screws, cams, bayonet style fittings, latches or other structures.

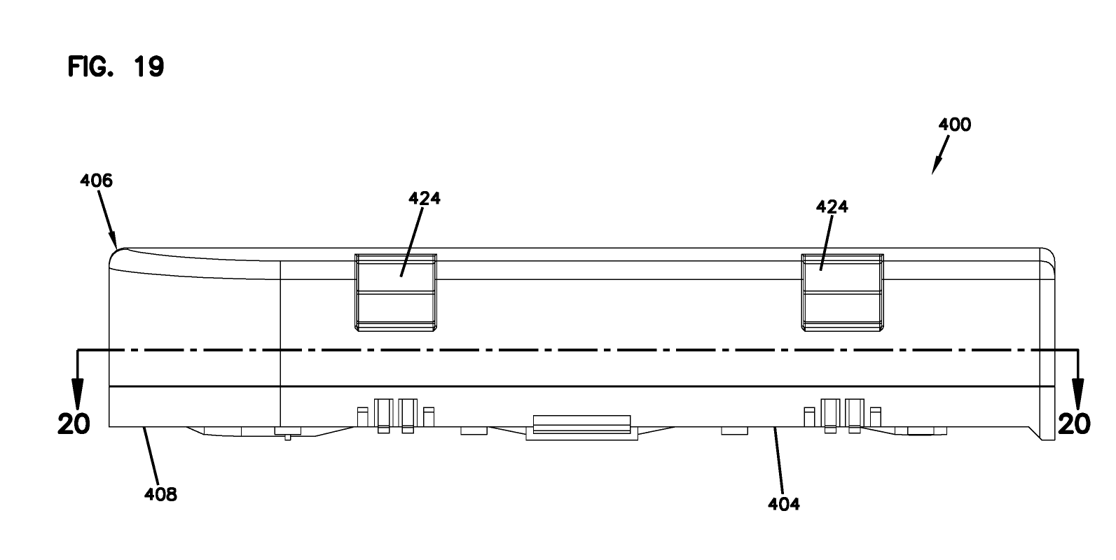

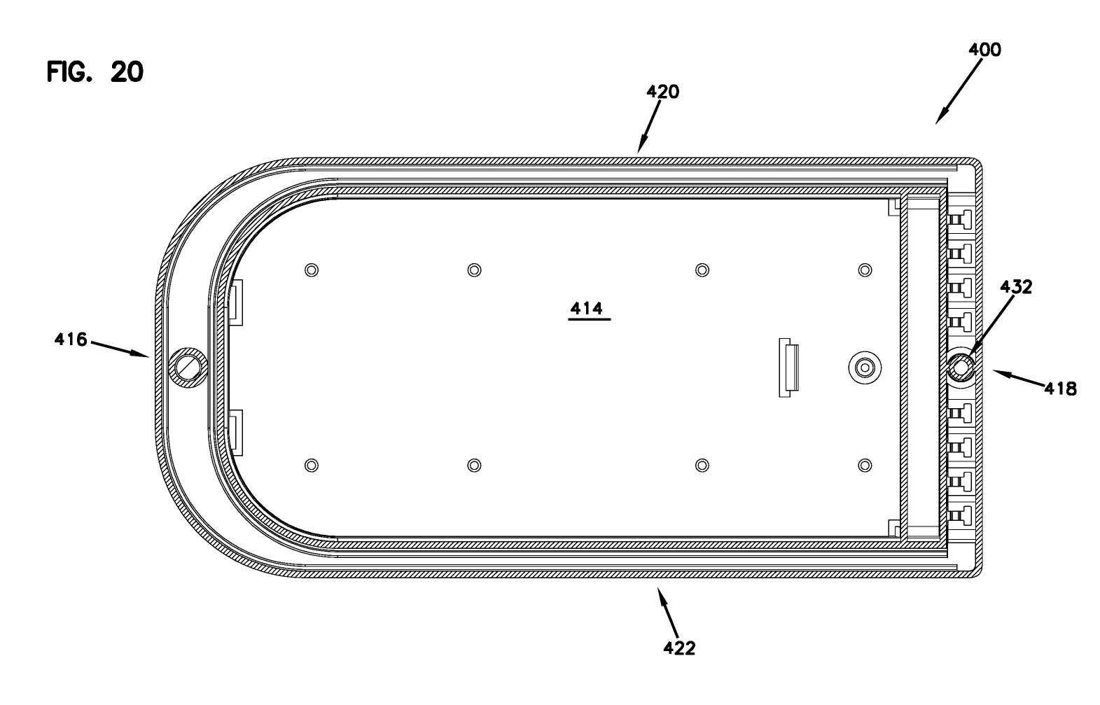

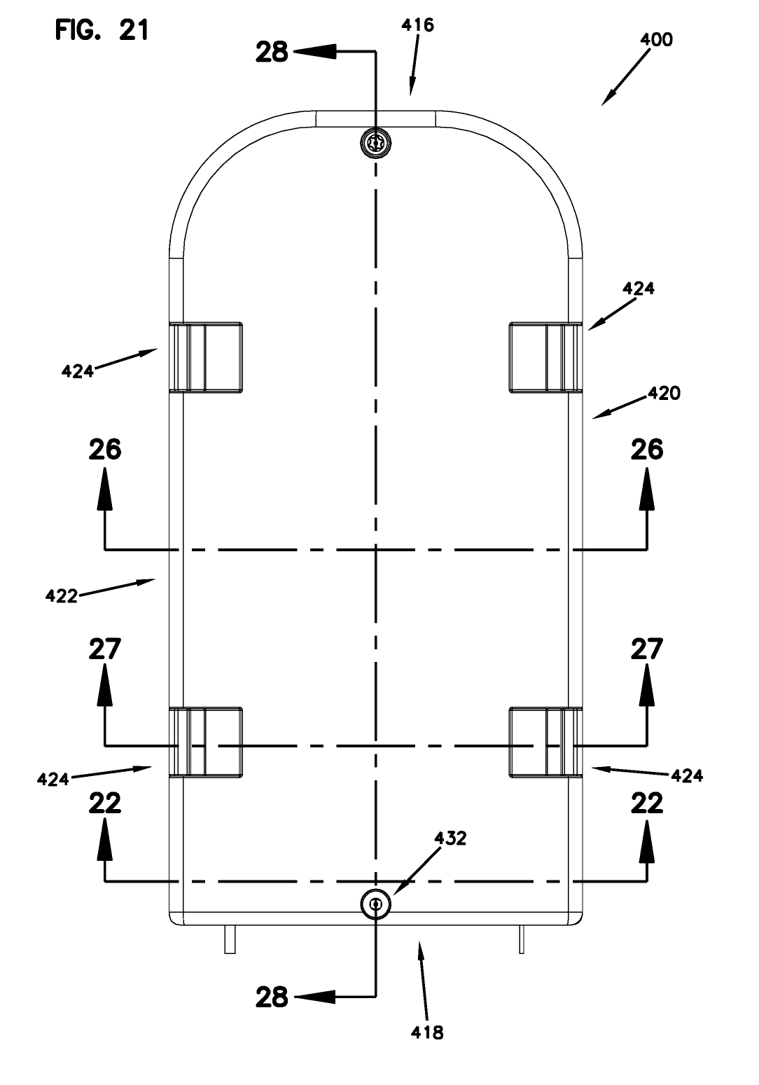

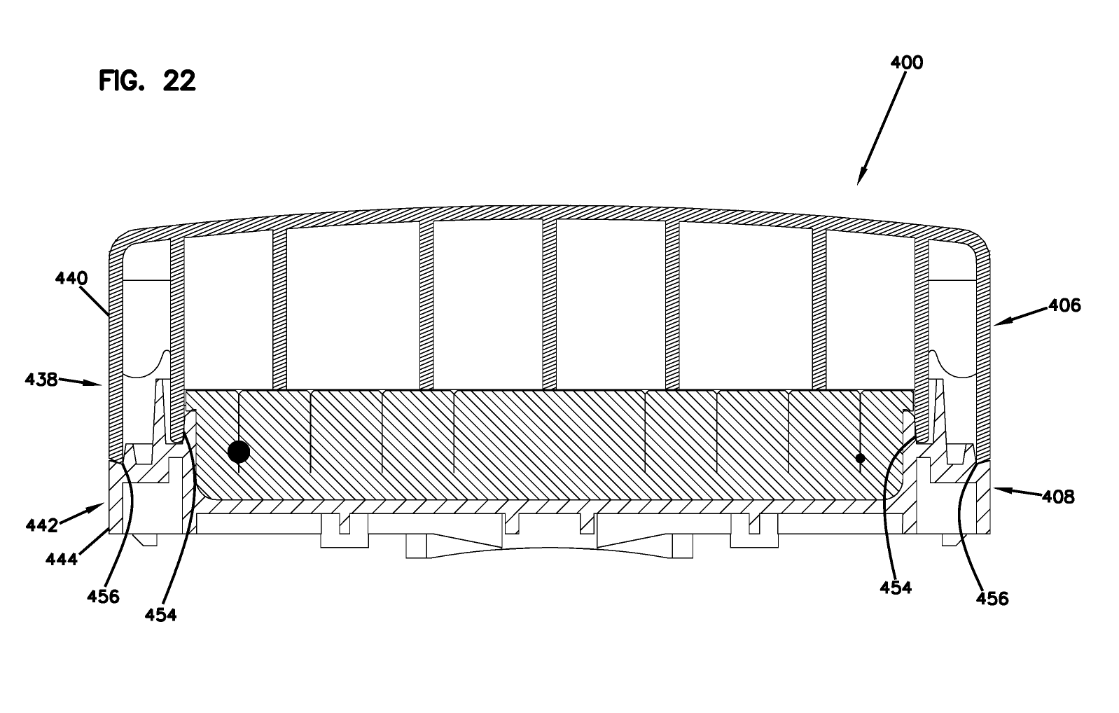

Referring to FIGS. 19 and 20, the perimeter sealing interface 410 extends around at least a majority of the perimeter of the housing 404. Referring to FIGS. 21 and 22, the perimeter sealing interface 410 includes a first sealing element 438 unitarily formed with a main body 440 of the front cover piece 406 and a second sealing element 442 unitarily formed with a main body 444 of the rear base piece 408.

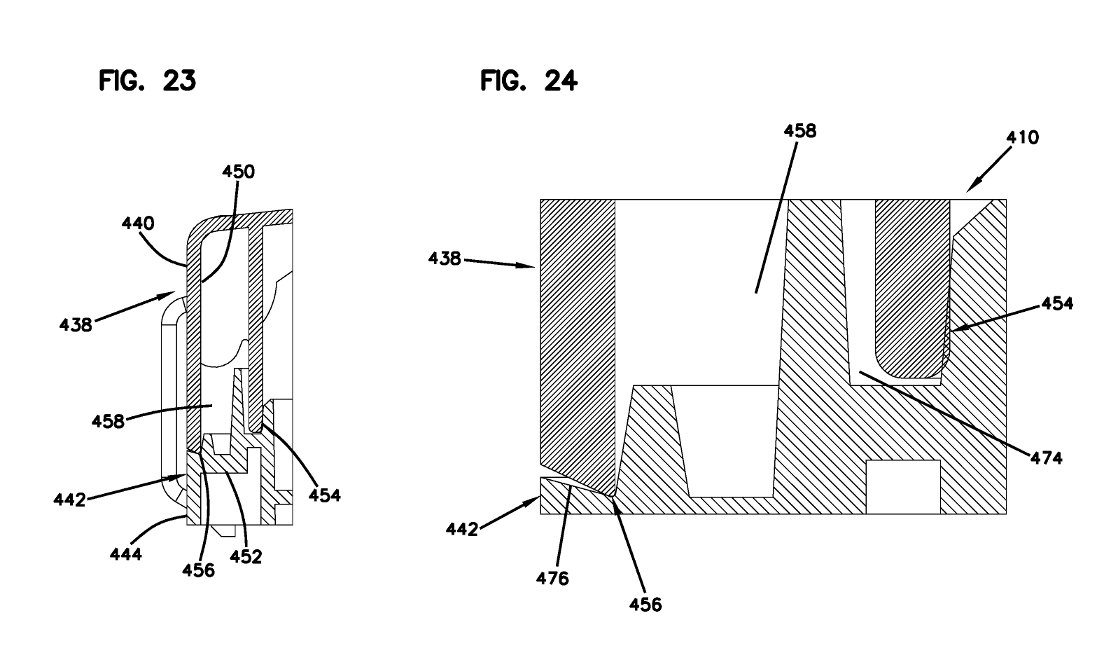

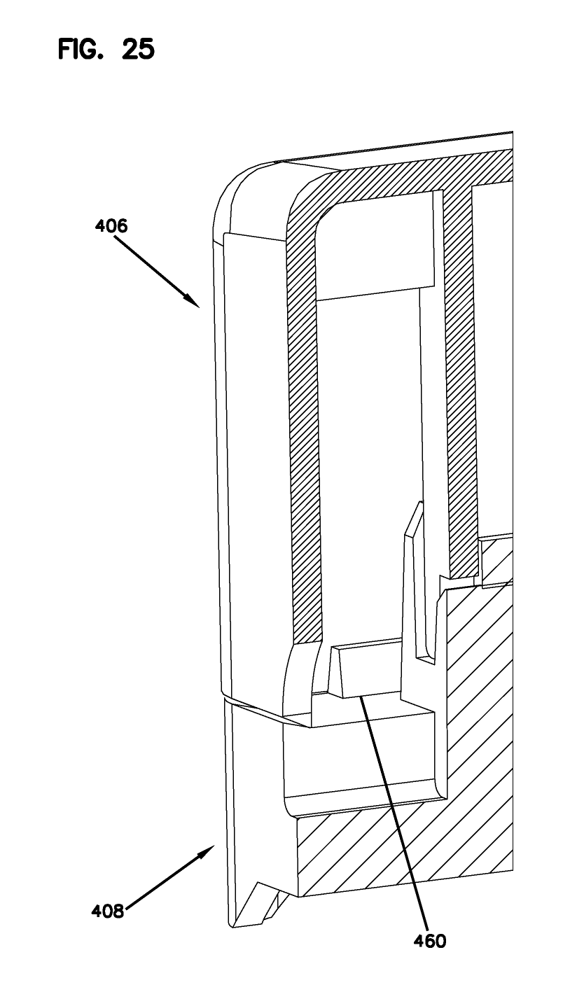

Referring to FIGS. 23 and 24, the first sealing element 438 defines a first sealing profile 450 and the second sealing element 442 defines a second sealing profile 452 configured to engage (e.g., interface, meet) with the first sealing profile 450 when the housing 404 is in the closed configuration. The first sealing profile 450 having a substantially straight configuration such that the first sealing element 438 can engage linearly with the second sealing profile 452 of the second sealing element 442. It will be appreciated that various features (e.g., fingers, flanges, projections, receptacles) of the first and second sealing profiles 450, 452 elastically flex as the first and second sealing profiles 450, 452 are engaged.

When the first and second sealing profiles 450, 452 are engaged, the first and second sealing profiles 450, 452 of the sealing interface 410 provide an inner sealing region 454 and an outer sealing region 456 separated by an expanded intermediate water pressure relief cavity 458. The intermediate water pressure relief cavity 458 forms a drainage channel 460 (see FIG. 25) that extends from the first drainage opening 426 continuously up the right side 422 of the housing 404, across the top side 416 of the housing 404, and down the left side 420 of the housing 404 to the second drainage opening 428. The drainage channel 460 allows any water that collects in the intermediate water pressure relief cavity 458 to drain from the sealing interface 410 via gravity out the first and second drainage openings 426, 428.

In certain examples, no elastomeric sealing elements, such as, a rubber O-ring or other like structure, are provided between the first and second sealing profiles 450, 452. Additionally, in certain examples, the first sealing element 438 and the second sealing element 442 are constructed of identical materials.

In certain examples, inner sealing region 454 can include either a contact-type seal such as a seam formed by interference between the first and second sealing profiles 450, 452 or a non-contact seal such as a labyrinth seal formed between the first and second sealing profiles 450, 452. Similarly, the outer sealing region 456 can be formed by a contact-type seal such as a seam formed by interference between the first and second sealing profiles 450, 452 or a non-contact seal such as a labyrinth seal formed between the first and second sealing profiles 450, 452.

It will be appreciated that during ingress protection testing, a water jet can be sprayed at the exterior of the housing 404. Under certain conditions, it may be possible for some water to pass through the outer sealing region 456 into the intermediate water pressure relief cavity 458. In this regard, it is preferred for the intermediate water pressure relief cavity 458 to have a transverse cross-sectional area that is sufficiently large such that any water passing through the outer sealing region 456 is de-pressurized so that the intermediate water pressure relief cavity 458 is maintained generally at atmospheric pressure. In this way, the intermediate water pressure relief cavity 458 prevents significant water pressure from being applied to the exterior side of the inner sealing region 454. In this way, the inner sealing region 454 provides better resistance to water intrusion. It will be appreciated that the exact transverse cross-sectional sizes of the intermediate water pressure relief cavity 458 is dependent upon the effectiveness of the outer sealing region 456 and variations in the test environment. However, in one non-limiting example, the intermediate water pressure relief cavity 458 can have a transverse cross-sectional area of at least 2 square millimeters.

As indicated above, the first and second sealing elements 438, 442 can be unitarily formed with their corresponding housing pieces. Thus, in certain examples, the first and second sealing elements 438, 442 can be made of relatively hard material suitable for providing mechanical protection (e.g., impact resistance, shock resistance, etc.). Example materials include plastic materials such as thermoplastic material or thermoset material. In certain examples, the material can include amorphous polymers. One example material can include polycarbonate (PC). Another example material can include acrylonitrile-styrene-acrylate (ASA). Other example materials can include blends or composites of any of the above materials. In certain examples, the materials can be UV-resistant. In certain examples, the materials can be low-smoke zero-halogen (LSZH) resins. In one example, the materials can exhibit a tensile modulus higher than 1800 megapascals (MPa), with a loading speed of 1 millimeter per minute, as tested according to the ISO 527 standard established by the International Organization for Standardization.

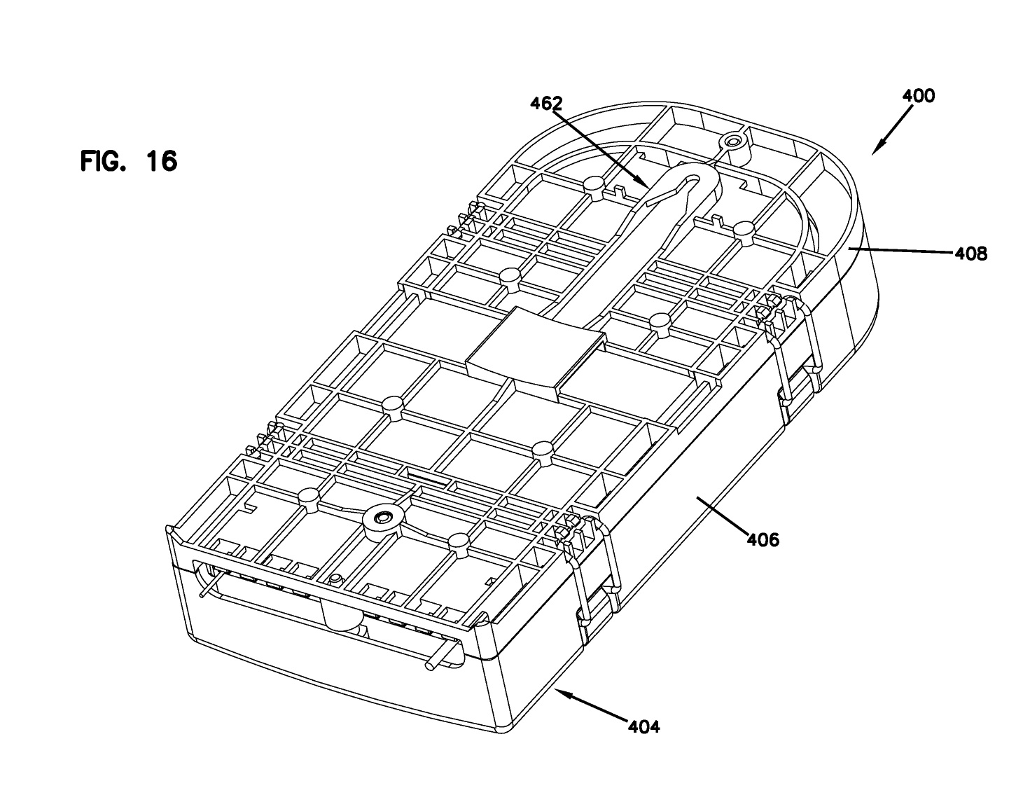

In certain examples, the enclosure 400 can be adapted to be mounted to a structure such as a wall, pole or other structure. In this regard, the housing 404 can include fastener openings used to receive fasteners for securing the enclosure 400 to a structure. It will be appreciated that the housing 400 can include a mounting element 462 (see FIG. 16) positioned on an opposite side of the major rear side 414 of the rear base piece 408. Additionally, fastener openings can be located in the rear base piece 408 of the housing 404 to mount the enclosure 400.

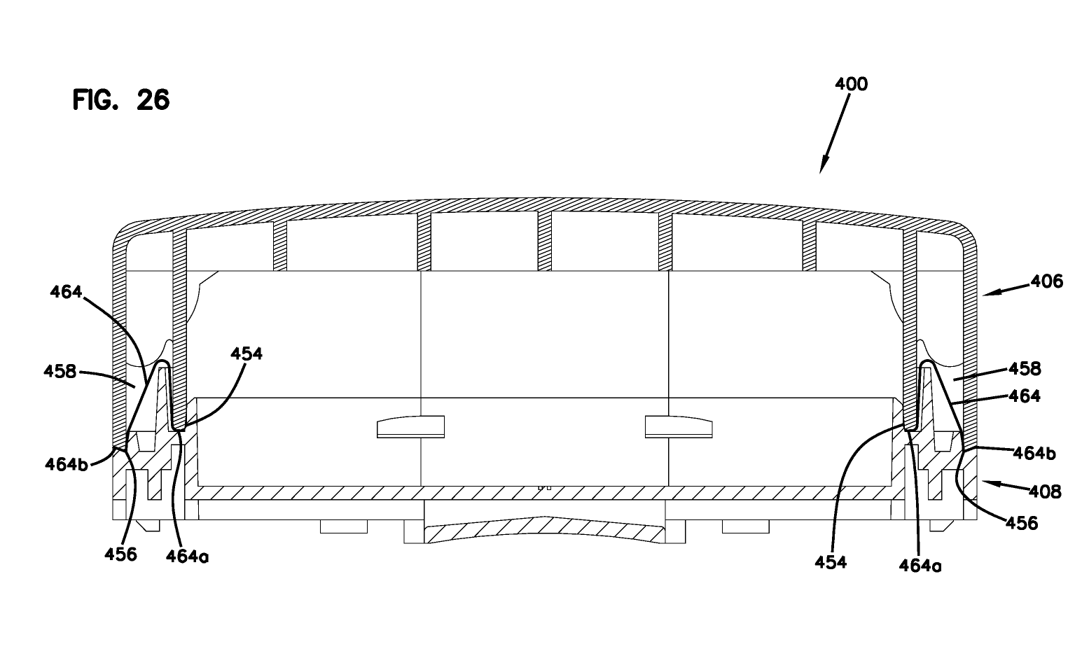

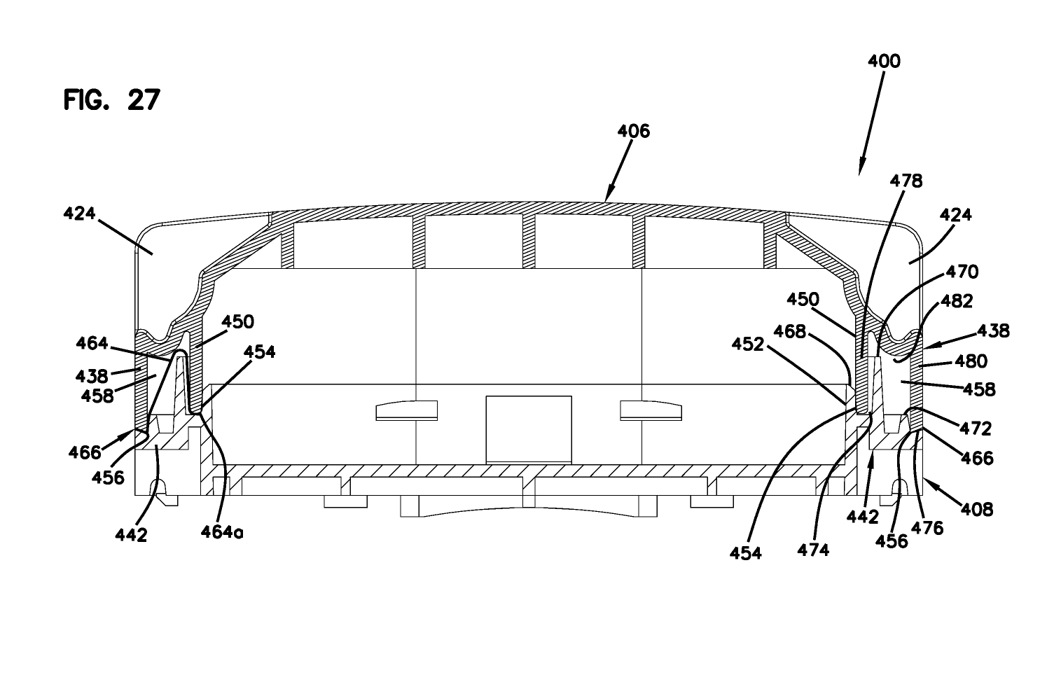

Referring to FIG. 26, the first and second sealing profiles 450, 452 can define an ingress path 464 having an inner end 464a adjacent the interior region 402 of the housing 404 and an outer end 464b spaced from the inner end 464a by a length of the ingress path 464. The inner sealing region 454, the intermediate water pressure relief cavity 458 and the outer sealing region 456 are positioned consecutively along the ingress path 464 as the ingress path 464 extends from the inner end 464a to the outer end 464b.

As shown at FIG. 27, the outer sealing region 456 extends generally to a free end 466 of the first sealing element 438. The outer end 464b (i.e., the entrance end) of the ingress path 464 is located at the free end 466 of the first sealing element 438.

The second sealing profile 452 includes an inner finger 468, an intermediate finger 470 and an outer finger 472 that cooperate to define a pocket 474 and a shoulder 476. The first sealing profile 450 includes an inner finger 478 and an outer finger 480 that cooperate to define a pocket 482. The inner and outer fingers 478, 480 both extend generally vertically from the main body 440 of the front cover piece 406. The inner finger 478 projects into the pocket 474 and the outer finger 480 projects into the shoulder 476. When the first and second sealing profiles 450, 452 are engaged together, the inner finger 478 of the first sealing profile 450 flexes against an outer surface of the inner finger 468 of the second sealing profile 452. The contact between the inner finger 478 and the finger 468 provides the inner sealing region 454. Additionally, the outer finger 480 of the first sealing profile 450 flexes against an outer surface of the outer finger 472 as it engages the shoulder 476. Contact between the outer surface of the outer finger 480 of the first sealing profile 450 and the shoulder 476 of the second sealing profile 452 provides the outer sealing region 456. The pockets 474, 482 cooperate to define the water pressure relief cavity 458 between the inner and outer sealing regions 454, 456.

Various modifications and alterations of this disclosure will become apparent to those skilled in the art without departing from the scope and spirit of this disclosure, and it should be understood that the scope of this disclosure is not to be unduly limited to the illustrative examples set forth herein.

### PARTS LIST

20—Enclosure
21—Fastener openings
22—Interior region
23—Fastener openings
24—Sealing interface
26—Housing
28—Front cover piece
30—Rear base piece
32—Major front side
34—Major rear side
36—Top side
38—Bottom side
40—Left side
42—Right side
44—Hinge
46—Pivot axis
50—First drainage opening
52—Second drainage opening
54—Opening
56—Latching arrangement
58—Fastener opening
60—Receptacle
62—First sealing element
63—Main body
64—Second sealing element
65—Main body
66—First sealing profile
68—Second sealing profile
70—Inner sealing region
72—Outer sealing region
74—Intermediate water pressure relief cavity
76—Drainage channel
78—Tabs
80—Ingress path
80a—Inner end
80b—Outer end
82—Direction
84—Free end
86—Barrier rib
88—Spray deflection surface
90—Direction
100—Inner finger
102—Outer finger
102a—First portion
102b—Second portion
103—Sub pocket
104—Pocket
106—End
108—Shoulder
110—Inner finger
112—Outer finger
114—Pocket
116—Intermediate finger
166—First sealing profile
168—Second sealing profile
169—Inner finger
170—Outer finger
171—Inwardly extending tip
172—Pocket
173—Stop surface
175—Inner finger
176—Outer finger
177—Intermediate finger
178—Stop surface
179—Pocket
180—Pocket
191—First sealing region
192—Second sealing region
193—Third sealing region
195, 196—Water pressure relief cavities
224—Sealing interface
266—First sealing profile
268—Second sealing profile
274—Water pressure relief cavity
324—Sealing interface
366—First sealing profile
368—Second sealing profile
380, 381, 382—Sealing regions
384—First water pressure relief cavity
385—Second water pressure relief cavity
400—Enclosure
402—Interior region
404—Housing
406—Front cover piece
408—Rear base piece
410—Perimeter sealing interface
412—Major front side
414—Major rear side
416—Top side
418—Bottom side
420—Left side
422—Right side
424—Clip arrangements
426—First drainage opening
428—Second drainage opening
430—Opening
432—Latching arrangement
433—Tie
434—Fastener opening
436—Receptacle
438—First sealing element
440—Main body
442—Second sealing element
444—Main body
446—Tie down locations
448—Support members
450—First sealing profile
452—Second sealing profile
454—Inner sealing region
456—Outer sealing region
458—Intermediate water pressure relief cavity
460—Drainage channel
462—Mounting element
464—Ingress path
464a—Inner end
464b—Outer end
466—Free end
468—Inner finger
470—Intermediate finger
472—Outer finger
474—Pocket
476—Shoulder
478—Inner finger
480—Outer finger
482—Pocket

1. An enclosure comprising:
a housing including a front cover piece and a rear base piece, the front cover piece being movable relative to the rear base piece between a closed position and an open position, the front cover piece connecting with the rear base piece at a perimeter sealing interface when in the closed position, the front cover piece and the rear base piece cooperating to define an interior of the housing when the front cover piece is in the closed position, the interior of the housing being accessible when the front cover piece is in the open position, the housing having a major front side defined by the front cover piece and a major rear side defined by the rear base piece, the housing further including a top side, a bottom side, a left side and right side, the perimeter sealing interface extending along at least the left side, the top side and the right side of the housing; and
the perimeter sealing interface including a first sealing element unitarily formed with a main body of the front cover piece and a second sealing element unitarily formed with a main body of the rear base piece, the first sealing element defining a first sealing profile and the second sealing element defining a second sealing profile, the first and second sealing profiles engaging when the front cover piece is in the closed position to provide inner and outer perimeter sealing regions separated by an expanded intermediate water pressure relief cavity, the intermediate water pressure relief cavity forming a drainage channel having open drainage ends adjacent the bottom side of the housing for draining via gravity water that collects in the water pressure relief cavity.

2. The enclosure of claim 1, wherein the bottom side of the housing defines a plurality of cable entrance openings, and
wherein the cable entrance openings have a wrap-around configuration.

3. (canceled)

4. (canceled)

5. The enclosure of claim 1, wherein no intermediate sealing element is provided between the first and second sealing elements.

6. (canceled)

7. The enclosure of claim 1, wherein the first sealing element resiliently snaps over the second sealing element to provide retention of the front cover piece on the rear base piece when the front cover piece is in the closed position.

8. The enclosure of claim 1, wherein the first sealing element resiliently engages the second sealing element when the front cover piece is connected to the rear base piece in the closed position.

9. (canceled)

10. (canceled)

11. (canceled)

12. (canceled)

13. The enclosure of claim 1, wherein the outer perimeter sealing region includes either: a) a first seam formed by interference between the first and second profiles of the first and second sealing elements; or 2) a first labyrinth seal formed between the first and second profiles of the first and second sealing elements; and
wherein the inner sealing region includes either: a) a second seam formed by interference between the first and second profiles of the first and second sealing elements; or 2) a second labyrinth seal formed between the first and second profiles of the first and second sealing elements.

14. (canceled)

15. (canceled)

16. An enclosure comprising:
a housing including a front cover piece and a rear base piece, the front cover piece being movable relative to the rear base piece between a closed position and an open position, the front cover piece mating with the rear base piece at a perimeter sealing interface when in the closed position, the front cover piece and the rear base piece cooperating to define an interior of the housing when the front cover piece is in the closed position, the interior of the housing being accessible when the front cover piece is in the open position, the housing having a major front side defined by the front cover piece and a major rear side defined by the rear base piece, the housing further including a top side, a bottom side, a left side and right side, the front cover piece being pivotally connected to the rear base piece by a hinge at the top side of the housing that allows the front cover piece to be pivoted relative to the rear base piece between the closed and open positions, the perimeter sealing interface extending along at least the left side, the top side and the right side of the housing; and
the perimeter sealing interface including a first sealing element unitarily formed with a main body of the front cover piece and a second sealing element unitarily formed with a main body of the rear base piece, the first sealing element defining a first sealing profile and the second sealing element defining a second sealing profile, the first and second sealing profiles interlocking when the front cover piece is in the closed position to provide inner and outer perimeter sealing regions separated by an expanded intermediate water pressure relief cavity, the intermediate water pressure relief cavity forming a drainage channel having open drainage ends adjacent the bottom side of the housing for draining via gravity water that collects in the water pressure relief cavity.

17. The enclosure of claim 16, wherein the intermediate water collection channel has a transverse cross-sectional area of at least 2 square millimeters.

18. The enclosure of claim 16, wherein the inner perimeter sealing region, the outer perimeter sealing region and the intermediate water pressure relief cavity extend continuously, without interruption, up the left side of the housing, over the top side of the housing and down the right side of the housing.

19. The enclosure of claim 16, wherein the outer sealing region includes either: a) a first seam formed by interference between the first and second profiles of the first and second sealing elements; or 2) a first labyrinth seal formed between the first and second profiles of the first and second sealing elements.

20. The enclosure of claim 16, wherein the inner sealing region includes either: a) a second seam formed by interference between the first and second profiles of the first and second sealing elements; or 2) a second labyrinth seal formed between the first and second profiles of the first and second sealing elements.

21. The enclosure of claim 16, wherein the first sealing element resiliently snaps over the second sealing element to provide retention of the front cover piece on the rear base piece when the front cover piece is in the closed position.

22. The enclosure of claim 16, wherein no intermediate sealing element is provided between the first and second sealing elements.

23. The enclosure of claim 16, wherein the first and second sealing elements are constructed of identical materials.

24. The enclosure of claim 21, wherein the outer sealing region includes an entrance end that is located at a free end of the first sealing element and that faces at least partially toward the main body of the rear base piece, wherein the outer sealing region defines an outer end of an ingress path between the first and second sealing profiles, the outer end of the ingress path facing toward the main body of the rear base piece, and
wherein the second sealing element includes a spray deflection surface that is oriented at an acute angle with respect to the main body of the rear base piece, the spray deflection surface being oriented to re-direct water spray directed upwardly against the main body of the rear base piece outwardly and downwardly in a re-direction orientation generally transverse with respect to an ingress path orientation defined at the outer end of the ingress path.

25. (canceled)

26. (canceled)

27. The enclosure of claim 16, wherein the bottom side of the housing defines a cable entrance opening, and
wherein the cable entrance opening has a wrap-around configuration.

28. (canceled)

29. (canceled)

30. (canceled)

31. An enclosure comprising:
a housing including a first housing piece and a second housing piece that mate together at a sealing interface to define an enclosed interior of the housing, the first housing piece including a main body and a first perimeter sealing element unitarily formed with the main body of the first housing piece, the second housing piece including a main body and a second perimeter sealing element unitarily formed with the main body of the second housing piece, the first sealing element defining a first sealing profile and the second sealing element defining a second sealing profile, the first and second sealing profiles interlocking at the sealing interface when the first and second housing pieces are mated together, the interlocked first and second sealing profiles defining an ingress path having an inner end adjacent the interior region of the housing and an outer end spaced from the inner end by a length of the ingress path, the first and second sealing profiles defining inner and outer perimeter sealing regions and an expanded intermediate water pressure relief cavity positioned along the ingress path, the intermediate water pressure relief channel being positioned between the inner and outer sealing regions, the outer end of the ingress path facing at least partially toward the main body of the first or second housing piece.

32. The enclosure of claim 31, wherein the first and second housing pieces are made of the same material, and
wherein the enclosure is at least IP55 rated.

33. (canceled)

34. The enclosure of claim 31, wherein the outer sealing region includes either: a) a first seam formed by interference between the first and second profiles of the first and second sealing elements; or 2) a first labyrinth seal formed between the first and second profiles of the first and second sealing elements; and
wherein the inner sealing region includes either: a) a second seam formed by interference between the first and second profiles of the first and second sealing elements; or 2) a second labyrinth seal formed between the first and second profiles of the first and second sealing elements.

35. (canceled)

36. The enclosure of claim 31, further comprising a barrier rib that projects from the main body of the first or second housing piece and that is positioned to prevent spray from a water jet from flowing along the main body to the outer end of the ingress path, and
wherein the housing is ventilated and at least IP55 rated.

37. (canceled)
